(19) United States
(12) Patent Application Publication
(10) Pub. No.: US 2024/0114127 A1
(43) Pub. Date: Apr. 4, 2024

(54) INTRA-PREDICTION FOR HEXAGONALLY-SAMPLED VIDEO AND IMAGE COMPRESSION

(71) Applicant: Dolby Laboratories Licensing Corporation, San Francisco, CA (US)

(72) Inventors: Zhaobin ZHANG, Kansas City, MO (US); Neeraj J. GADGIL, Pune (IN); Guan-Ming SU, Fremont, CA (US)

(73) Assignee: Dolby Laboratories Licensing Corporation, San Francisco, CA (US)

(21) Appl. No.: 18/264,311

(22) PCT Filed: Feb. 10, 2022
(86) PCT No.: PCT/US2022/015930

§ 371 Date: Aug. 4, 2023

Related U.S. Application Data
(60) Provisional application No. 63/148,258, filed on Feb. 11, 2021.

(30) Foreign Application Priority Data
Feb. 11, 2021 (EP) 21156500.7

(51) Int. Cl. H04N 19/105; H04N 19/119; H04N 19/159; H04N 19/176

(52) U.S. Cl. CPC H04N 19/105; H04N 19/119; H04N 19/159; H04N 19/176

(57) ABSTRACT

Methods, systems, and devices implement intra-prediction for hexagonally-sampled compression and decompression of videos and images having a regular grid of hexagonally-shaped pixels. For encoding, a prediction unit (PU) shape is selected at a sequence level from the group consisting of parallelogram, zigzag-square, hexagonal super-pixel, a rectangular zigzag and an arrow, and the hexagonally-sampled image is divided into regions based on the PU shape. For each region: a prediction mode and a PU size are determined; reference pixels are determined for each predicted pixel in the PU shape based on the prediction mode; a weighted factor is determined for each of the reference pixels based on a distance between the reference pixel and the predicted pixel; and a predicted value of each of the predicted pixels in the PU shape is determined using the corresponding reference pixels and the weighted factors.

### CROSS-REFERENCE TO RELATED APPLICATIONS

This application claims priority of U.S. Provisional Patent Application No. 63/148,258, filed Feb. 11, 2021, and European Patent Application No. 21156500.7, filed Feb. 11, 2021, both of which are incorporated herein by reference in their entirety.

### TECHNICAL FIELD

The present application relates to intra-prediction techniques, and more particularly, to intra-prediction for hexagonally-sampled compression and decompression of videos and images.

### BACKGROUND

Cameras and other image capturing devices collect images that are captured, processed, stored, and displayed. These devices may use square or rectangular shaped pixels at a number of locations where sampling is performed (e.g., sampling locations). An image sensor may capture a sample of light propagating from an imaged scene specify that is incident at a first location (e.g., of a pixel array of an image sensor) and may measure an intensity of the sample in a color-channel in some color space. The value for the intensity may correspond to the intensity of the light sample at a particular rectangular spatial region. Based on the intensity for this region, the rectangular based device may generate a rectangular pixel grid. A rectangular pixel grid may be used for a relatively straightforward way of storing, processing and displaying image information.

It is well known that the human visual system includes hexagonal arrangements of sensors in what is known as the human foveal region of the retina (e.g. cones). Isotropically band-limited two-dimensional signals can be represented with fewer pixels when sampled hexagonally versus rectangularly. Thus, rectangular sampling with rectangular pixel grids is not optimal. Moreover, other sampling geometries may have characteristics that provide additional flexibility and greater performance than rectangular sampling offers.

### SUMMARY

The described techniques relate to improved methods, systems, devices, and apparatuses that support intra-prediction for hexagonally-sampled compression and decompression of videos and images. Generally, the described techniques provide for determining a prediction unit (PU) shape for performing intra-prediction on a block of pixels of a hexagonally-sampled image. That is, due to improved isoperimetry properties, a variety of PU shapes may be used. For example, a PU shape to be used for intra-prediction may be selected from the PU shapes: parallelogram, zigzag-square, hexagonal super-pixel, where the hexagonal super-pixel may be or include one or both of a rectangular zigzag and/or an arrow shape, among other PU shapes described herein.

To exploit tight-packing of hexagonal lattices and achieve related performance gains, techniques for intra-prediction for hexagonal grid are provided herein. For example, the techniques described herein provide for, after determining the PU shape, intra-prediction is used to predict a value for each pixel of the PU shape. In some examples, hexagonal grid provides new design prediction methods, which may in turn reduce prediction errors and create relatively improved visual outcomes. In particular, two block-based intra-prediction techniques for hexagonally-sampled images are described.

### BRIEF DESCRIPTION OF THE DRAWINGS

FIG. 1 shows an example of a rectangular sampling scheme and an example of a hexagonal sampling scheme that supports intra-prediction for hexagonally-sampled compression and decompression of videos and images, in embodiments.

FIG. 2 shows an example imaging pipeline for a hexagonal sampling procedure that supports intra-prediction for hexagonally-sampled compression and decompression of videos and images, in embodiments.

FIG. 3 shows an example conversion between a square-sampled image and a hexagonally-sampled image that supports intra-prediction for hexagonally-sampled compression and decompression of videos and images, in embodiments.

FIG. 4 shows example visualization results of converting a square-sampled image to a hexagonally-sampled image that supports intra-prediction for hexagonally-sampled compression and decompression of videos and images by the hexagonal-sampled video compression algorithm of FIG. 2, in embodiments.

FIG. 5 shows one example parallelogram PLT shape that supports intra-prediction for hexagonally-sampled compression and decompression of videos and images, in embodiments.

FIG. 6 shows one example zigzag-square PU shape that supports intra-prediction for hexagonally-sampled compression and decompression of videos and images, in embodiments.

FIG. 7 shows an example of a hexagonal super-pixel PU shape that supports intra-prediction for hexagonally-sampled compression and decompression of videos and images, in embodiments.

FIG. 8 shows an example of an arrow PU shape that supports intra-prediction for hexagonally-sampled compression and decompression of videos and images, in embodiments.

FIG. 9 shows an example of a rectangular zigzag PU shape that supports intra-prediction for hexagonally-sampled compression and decompression of videos and images, in embodiments.

FIG. 10 is a diagram illustrating angular prediction modes for deriving a prediction for intra-prediction for square-sampled compression and decompression of videos and images as described by conventional High Efficiency Video Coding (HEVC) implementations.

FIG. 11 is a diagram illustrating angular prediction modes corresponding to the angular prediction modes of FIG. 10 as applied to the parallelogram PU shape of FIG. 5, in embodiments.

FIG. 12 shows a representation of a non-shifted hexagonally-sampled image and a representation of a forward shifted image that facilitates pixel addressing by conventional High Efficiency Video Coding (HEVC) implementations, in embodiments.

FIG. 13 shows an example representation of equal-angle prediction modes for the parallelogram PU shape of FIG. 5, in embodiments.

FIGS. 14A, 14B, and 14C show reference pixels for three directional planar mode interpolations for the zigzag-square PU shape of FIG. 6, in embodiments.

FIG. 15 shows a generalization of rules for selecting reference pixels for the three directions of the planar mode interpolations of FIGS. 14A, 14B, and 14C, in embodiments.

FIG. 16 shows a DC mode for a zigzag square prediction scheme that supports intra-prediction for hexagonally-sampled compression and decompression of videos and images, in embodiments.

FIG. 17 is a diagram illustrating example angular prediction modes for the zigzag-square PU shape of FIG. 6, in embodiments.

FIG. 18 shows the zigzag-square PU shape of FIG. 6 and demonstrates how an angle between Mode 2 and Mode 9 may be derived, in embodiments.

FIG. 19 shows the zigzag-square PU shape of FIG. 6 with several reference pixels to illustrate how weighting factors are derived, in embodiments.

FIGS. 20-24 show five example calculations for calculating bilinear weights for reference pixels, in embodiments.

FIG. 25 shows one example processing system that supports intra-prediction for hexagonally-sampled compression and decompression of videos and images, in embodiments.

FIGS. 26A and 26B show examples of network environments that support intra-prediction for hexagonally-sampled compression and decompression of videos and images, in embodiments.

FIG. 27 is a flowchart illustrating one example method for encoding a hexagonally-sampled image that supports intra-prediction for compression of hexagonally-sampled videos and images, in embodiments.

FIG. 28 is a flowchart illustrating one example method for decoding an encoded hexagonally-sampled image using intra-prediction, in embodiments.

### DESCRIPTION OF EXAMPLE EMBODIMENTS

The techniques described herein provide for a method for intra-prediction using hexagonal sampling. Some devices, such as cameras and other devices with which a camera may be integrated, may adopt image sensors with hexagonal arrays for hexagonally-based compression (and similarly, decompression) of video and other images. This may provide various advantages over image sensors configured in, for example, rectangular arrays. Digital images that are captured, processed, stored and displayed may use square or rectangular shaped pixels at a number of locations where sampling is performed (i.e., sampling locations). An image sensor may capture a sample of light that is incident at, or centered at a first location that has a value of p(x, y) specifying its intensity in a color-channel in some color space. This value for the intensity may represent a rectangular spatial region centered around (x, y), from which the rectangular based device may form a rectangular pixel grid. A rectangular pixel grid may be used for a relatively straightforward way of storing, processing and displaying image information.

It is well known, however, that the human visual system includes hexagonal arrangements of sensors in what is known as the human foveal region of the retina (e.g. cones). According to some multi-dimensional sampling theories, a regular hexagonal grid may provide an improved or optimal sampling lattice for two-dimensional isotropically band limited signals. Likewise, it has been demonstrated that a hexagonal grid is an improved or even optimal sampling lattice for isotropically band limited two-dimensional signals, for example, providing substantial improvements in sampling efficiency over rectangular sampling (e.g., improvements of 10% or more), meaning that the signal can be represented with fewer pixels (e.g., 10% fewer) when sampled hexagonally versus rectangularly.

Hexagonal sampling techniques described herein provide advantages in image and video compression in many typical applications. To use hexagonal arrays, newer and relatively more efficient coding techniques may be implemented for image sensors to encode and decode information for the hexagonal arrays. However, there may be relatively fewer hexagonal sensors among commercially available image capture devices and thus relatively fewer hexagonally-sampled images for processing.

As such, it is contemplated that a device may receive traditionally-sampled images, such as a rectangularly-sampled image, as an input. As used herein, the terms square-sampled image and rectangularly-sampled image may be used interchangeably to refer to images captured using conventional rectangularly-shaped or square-shaped sensing pixels. The device may then convert the rectangularly-sampled image to a hexagonally-sampled image, perform intra-coding prediction (i.e., intra-prediction) on the hexagonally-sampled images, and convert these hexagonally-sampled (or, e.g., alternatively referred to as “hex-sampled”) images back to the original image format, for example, returning to a set of rectangularly-sampled images. Several prediction unit (PU) shapes are described herein that may be used for performing this encoding of hexagonally-sampled images. In embodiments, a PU shape utilizes a hexagonal sampling grid, such as grids arranged as parallelograms, zigzag squares, hexagonal super-pixels, and any combination of these and/or other like PU shapes.

Additionally, multiple prediction modes are also described herein for this hexagonally based intra-prediction. These prediction modes may be used with hexagonal imaging grids, where, in embodiments, a decoding device derives corresponding reference pixel locations and interpolation weighted factors according to the PU shape.

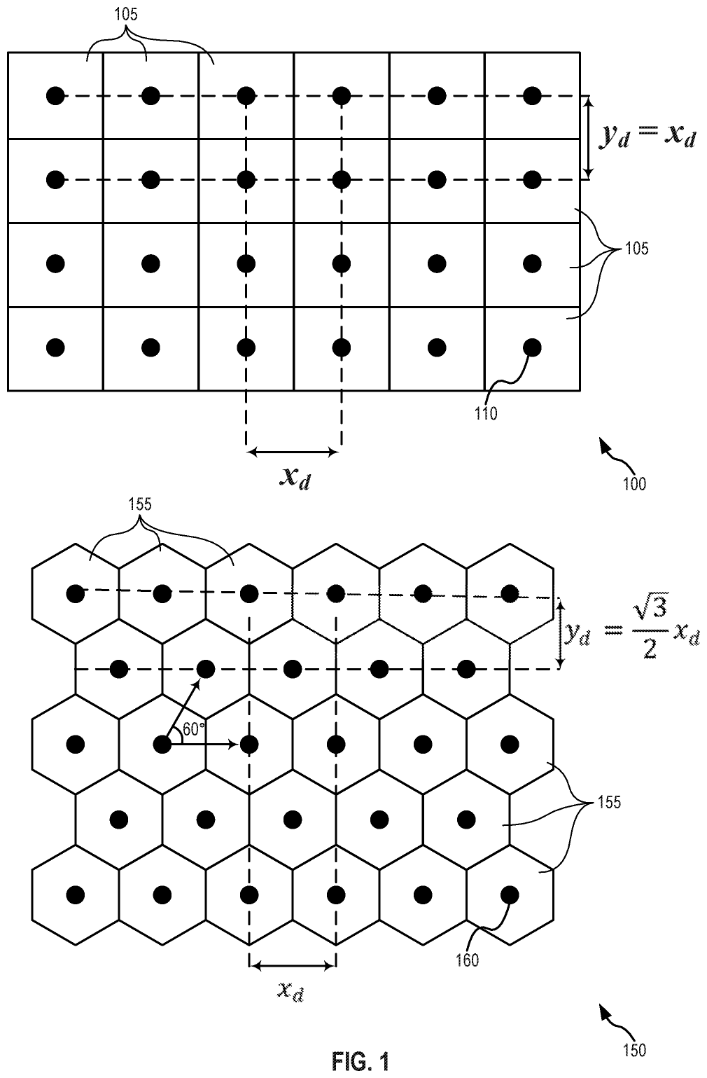

FIG. 1 shows an example of a rectangular sampling scheme 100 and an example of a hexagonal sampling scheme 150 that supports intra-prediction for hexagonally-sampled compression and decompression of videos and images, in embodiments. Rectangular scheme 100 includes a grid of pixels, where each pixel 105 has dimensions given by x_{d}×y_{d}, and where x_{d}=y_{d}, thus being a square pixel grid. Each pixel 105 has a pixel center 110, indicated by a dot. The distance between two adjacent pixel centers 110 in the same row or column is given by x_{d} or y_{d}, respectively, and the distance between two between diagonally adjacent pixels is given by \sqrt{x_{d}²+y_{d}²}. Hexagonal sampling scheme 101 includes a hexagonal pixel grid of pixels 155, where each pixel 155 has a shape of a regular hexagon. Each pixel 155 has a pixel centers 160 indicated by a dot. Maintaining generality, the distance between two adjacent pixels 155 in a row of the grid of the hexagonal sampling scheme 150 is again x_{d}, and the distance between two adjacent pixel-rows (e.g., between pixel centers 160) of the hexagonal pixel grid is given by

$$\\ {y}_{d} = \frac{\sqrt{3}}{2} {x}_{d} .$$

The angle between lines connecting one pixel center 160 to its two adjacent neighbors is 60°. The discussion herein, in some examples, refers to these example configurations of square pixels and regular hexagons, but it is to be appreciated that other like techniques may be used similarly with respect to other regular shapes.

By their respective definitions, a hexagonally-sampled image has three primary directions, whereas a square-sampled image has two primary directions. Directly reusing intra-prediction techniques for square-sampled images with hexagonally-sampled images may lead to sub-optimal performance due to this difference in the number of primary directions. For example, intra-prediction techniques for square-sampled images may ignore some features of hexagonally-sampled images. For example, the PU shapes for hexagonally-sampled images are different from PU shapes for square-sampled images due to the property of equidistance between neighboring pixels (which may be referred to herein as, e.g., reference pixels), and other like differences between properties of hexagonally-sampled images square-sampled images.

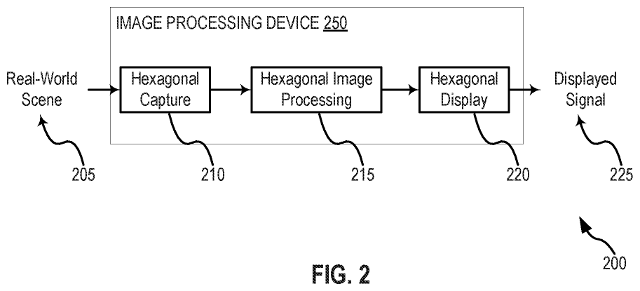

FIG. 2 shows one example imaging pipeline 200 for hexagonal image processing that supports intra-prediction for hexagonally-sampled compression and decompression of videos and images, in embodiments. A real-world scene 205 is captured by a hexagonal capture process 210 (e.g., by an image sensor or imaging device such as a camera or other similar device) as a hexagonally-sampled image. A hexagonal-sampled video compression algorithm 215 processes and stores the hexagonally-sampled image in the same hexagonally-sampled domain. A hexagonal display process 220 outputs the processed hexagonally-sampled image as a displayed signal 225. In certain embodiments, where a display device does not implement hexagonal-shaped output pixels, hexagonal display process 220 may convert the processed hexagonally-sampled image to a square-sampled image for output to a square-shaped output pixel device. In some examples, the displayed signal 225 may fulfil one or more objectives, such as approximating the real-world scene 205, realizing a creative intent, maximizing (e.g., improve the enjoyability of) a user's viewing experience, and other like purposes of capture and display devices.

In some cases, hexagonally-sampled content may not be available, because currently hexagonal-based content is not available and/or technology has not made it reasonably usable yet (e.g., having not been developed). While hexagonal-based content is likely to be more readily available in the future, many users will likely continue to use other traditional technologies. Accordingly, hexagonal capture process 210 may include capturing a non-hexagonally-sampled image (e.g., a square-sampled image) and using a resampling technique that generates a hexagonal-sampled image from the non-hexagonally-sampled image.

To exploit tight-packing of hexagonal lattices and realize the corresponding performance gains, techniques for intra-prediction using a hexagonal grid are described. Intra prediction is an important tool for compression of still-image and moving pictures (video). Hexagonal-sampled video compression algorithm 215 uses new design prediction methods that are developed for use with the hexagonally sampled images and the hexagonal grid to reduce prediction errors and improve visual outcomes. Embodiments herein describe two block-based intra-prediction techniques for hexagonal-sampled images. Hexagonal capture process 210, hexagonal-sampled video compression algorithm 215, and hexagonal display process 220 may be implemented in an image processing device 250, or in multiple devices, that may or may not include an image capture device (e.g., a camera) and a display device (e.g., an output device). Examples of image processing device 250 may include a smartphone or other user equipment (LIE) that captures a real-world scene using a hexagonal grid of sensors, or using a square grid of sensors and resampling technique that converts a square-sampled image to a hexagonally-sampled image, although principles discussed herein apply to an image sensor. The device may include computer hardware, such as a processor, memory, and so on,

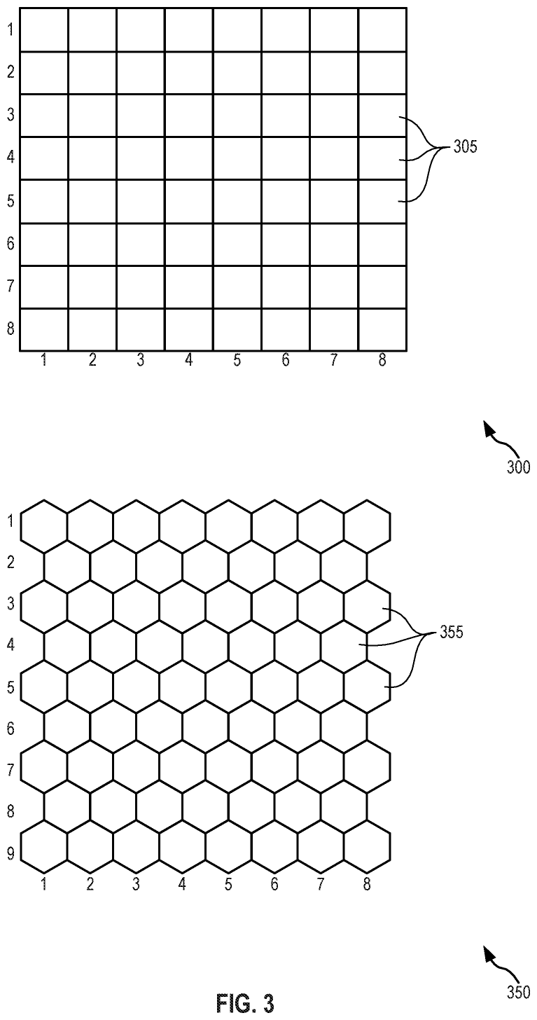

FIG. 3 shows an example conversion of a square-sampled image 300 to a hexagonally-sampled image 350 to support intra-prediction for hexagonally-sampled compression and decompression of videos and images, in embodiments. Such conversion may be used where an image capture device that captures hexagonally-sampled images is unavailable. In the example of FIG. 3, square-sampled image 300 is a square array having eight rows and eight columns of pixels 305. In certain embodiments, each pixel 305 is a single value, for example representing one of red, green, or blue. In other embodiments, the square-sampled image 300 is a demosaiced image (e.g., generated by applying a demosaicing algorithm for reconstructing a full color image), where each pixel 305 represents a combined color value.

In certain embodiments, the conversion from square-sampled image 300 to hexagonally-sampled image 350 is performed by image processing device 250 in place of hexagonal capture process 210 of FIG. 2.

An interpolation-based solution may be used to resample square-sampled image 300 to a hexagonally-sampled image 350. Because the vertical distance y_{d} between adjacent rows of pixels 355 in hexagonally-sampled image 350 is different from the distance between adjacent rows of square-sampled image 300, the values of each pixel 355 with center point that does not spatially coincide with a center point of any pixel 305 is not known (e.g., referred to as a non-existing point), and is predicted using interpolation. Values of pixels 355 may be interpolated in two operations (or, more operations or fewer operations, in other implementations). In an example, without limitation, first, bicubic interpolation is applied along the vertical axis of the square-sampled image to adjust its image height to generate a rectangular height adjusted image. Then, in a second operation, since pixels in odd rows have a half-pel location shift (i.e., a shift of one half pixel) from the height-adjusted image to hexagonally-sampled image 350, an 8-tap filter may be applied according to a horizontal resampling scheme to sample the half pixel location. The following equation provides example MPEG-specified 8-tap filter weights:

coeff=[22,94,−524,2456,2456,−524,94,22]/4096.

As shown in FIG. 3, given a square-sampled image of size wₛ×h₅, where wₛ denotes width and hₛ represents height, the following set of operations may be performed to derive hexagonally-sampled image 350 from square-sampled image 300.
a) Calculate the height of hexagonally-sampled image 350, that is, as given by:

$$\\ {h}_{h} = ⌊ \frac{{h}_{s}}{\sqrt{3} / 2} ⌋ ,$$

where the width of the hexagonally-sampled image remains the same as that of square-sampled image 300. Here, the height of the hexagonally-sampled image, hₕ, represents the number of rows (e.g., rather than the spatial height when visualizing the image).
b) Use an interpolation algorithm (e.g., bicubic interpolation) to increase the height of the square-sampled image from hₛ to hₕ.
c) For all even rows, apply the dedicated 8-tap filter to derive the half-pel pixel values.

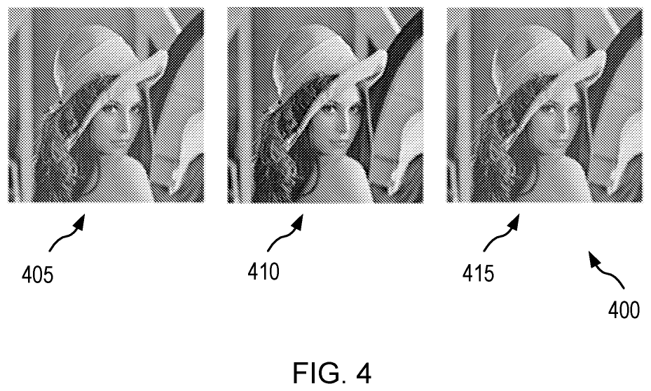

FIG. 4 shows example visualization results 400 of converting a square-sampled image 405 to a hexagonally-sampled image 410 that supports intra-prediction for hexagonally-sampled compression and decompression of videos and images by hexagonal-sampled video compression algorithm 215 of FIG. 2, in embodiments. In certain embodiments, as described above, hexagonal capture process 210 of FIG. 2 may first capture real-world scene 205 as square-sampled image 405 using a square grid of sensors and then convert square-sampled image 405 to hexagonally-sampled image 410 using the resampling technique.

Conversion 400 from the square-sampled image 405 to the hexagonally-sampled image 410 may be reversed to convert a hexagonally-sampled image to a square-sampled image. FIG. 4 shows a reconstructed square-sampled image 415 that is generated from hexagonally-sampled image 410. Given a hexagonally-sampled image, the integer-pel location values may be derived with the 8-tap filter for all the even rows. Interpolation (e.g., Bicubic interpolation) may be applied to further resize the height from hₕ to hₛ. FIG. 4 shows example visualization results of converting from square-sampled image 405 to hexagonal-sampled image 410 and then to reconstructed square-sampled image 415.

### Intra-Prediction for Hexagonal Grid

According to a first intra-prediction technique, hexagonal-sampled video compression algorithm 215 of FIG. 2 implements intra-prediction with a hexagonal grid. Hexagonally-sampled images possess unique characteristics, including, for example, isoperimetry (e.g., having more equidistant neighboring pixels) and/or uniform connectivity (e.g., thus being more likely to be suitable for a greater variety of PU shapes with a dedicated prediction scheme). Using (e.g., repurposing) a scheme designed for intra-prediction of square-sampled images may provide relatively inferior performance, for example, because the scheme would not take advantage of these characteristics.

Hexagonally-sampled images possess one or more of several advantages over square-sampled images. For example, hexagonally-sampled images may possess isoperimetry. Per the isoperimetric theorem, a hexagon encloses more area than any other closed planar curve of equal perimeter, except a circle. This implies that the sampling density of a hexagonal lattice is higher than that of a square lattice.

Additionally, pixels of hexagonally-sampled images also have a greater number of equidistant neighbors. Every hexagon in the lattice (e.g., hence each hexagonal pixel in an image) has six equidistant neighbors with a shared edge. In contrast, a square pixel 9) has only four equidistant neighbors with a shared edge or a corner. This implies that curves can be represented in a better fashion on the hexagonal lattice and following an edge will be easier. Hexagonally-sampled images may also possess uniform connectivity (e.g., having only one type of neighborhood). Thus, there will be less ambiguity when defining boundaries and regions.

In square-sampled images, a two-axis addressing system is typically used. While a three-axis addressing system may be used for hexagonal-sampled images, this may cause ambiguity while switching between square-sampled images and hexagonally-sampled images. As such, the following examples use a two-axis coordinate system when accessing pixel values of hexagonally-sampled images. Due to a better isoperimetry property, hexagonal-sampled video compression algorithm 215 of FIG. 2 may use a variety of different PU shapes for intra-prediction. These PU shapes may be selected from the group of PU shapes including: parallelogram, zigzag-square, and/or hexagonal super-pixel, where the hexagonal super-pixel is, or includes, one or both of a rectangular zigzag and/or an arrow shape. A PLT shape may also be based on a deviation from or combination of multiple of ones of these shapes.

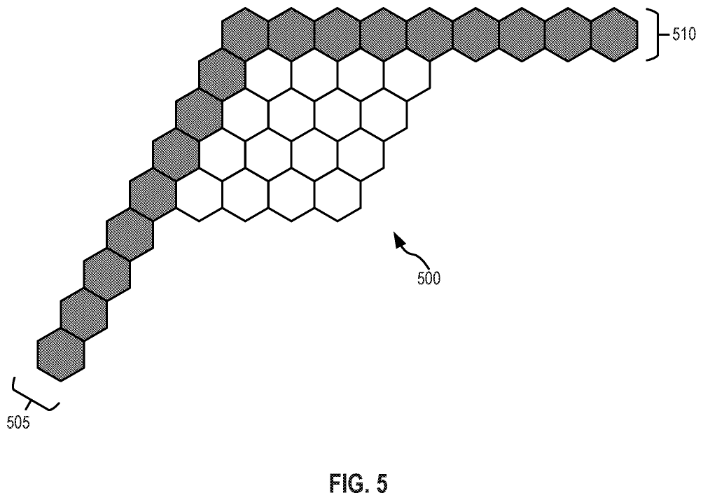

FIG. 5 shows one example parallelogram PU shape 500 that supports intra-prediction for hexagonally-sampled compression and decompression of videos and images, in embodiments. In some examples, the parallelogram PU shape 500 may be implemented by image processing device 250 and/or hexagonal-sampled video compression algorithm 215.

As shown in the example of FIG. 5, the parallelogram PU shape 500 follows the design philosophy of a square-sampled image PU. However, instead of using an N×N square PU, the parallelogram PU shape 500 is similar to a N×N skewed-square PU, such that left reference pixels 505 are “tilted” 300 in a clockwise direction. However, in other embodiments, the skew may be in the opposite direction where the left reference pixels are tilted in a counter-clockwise direction). The top reference pixels 510 are arranged similar to a square-sampled image. As shown in FIG. 5, the left reference pixels 505 are spreading from the top-right of the Figure toward the bottom-left. Based on the geometric properties of a regular hexagon, the angle between the spreading direction of the left reference pixels 505 and the horizontal is 60°.

In some examples, the parallelogram PU shape 500 may implement some aspects similar to those used with some other models, such as the model for a High Efficiency Video Coding (HEVC) test mode, since angular prediction modes may be derived based on an offset of reference pixel locations (e.g., relative to one another). In addition, the boundaries of the parallelogram PU shape 500 are consistent, providing, for example, consistency and reliability.

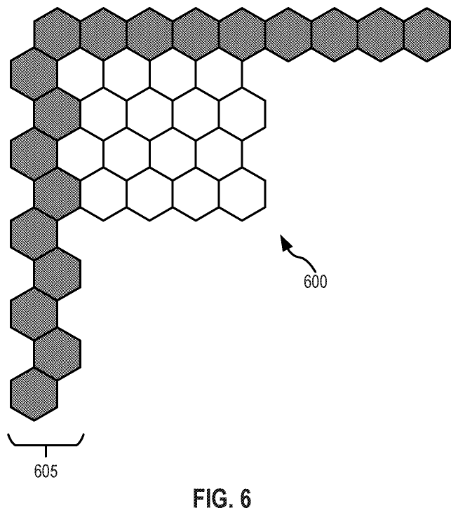

FIG. 6 shows one example zigzag-square PU shape 600 that supports intra-prediction for hexagonally-sampled compression and decompression of videos and images, in embodiments. As evident from FIG. 6, the zigzag-square PU shape comprises a number of adjacent equal-length rows, wherein the number of rows is equal to the length of each row. In some examples, the zigzag-square PU shape 600 may be implemented by image processing device 250 and/or hexagonal-sampled video compression algorithm 215.

As shown in the example of FIG. 6, the zigzag-square PU shape 600 has a zigzag pixel arrangement. In hexagonally-sampled images, every other row has a half-pel offset with respect to its adjacent rows. Zigzag-square PU shape 600 is a most likely (e.g., most common) occurring PU shape in hexagonally-sampled images, as is the use in HEVC of the square PU shape in square-sampled images. For the zigzag-square PU shape 600, the left reference pixels 605 are not perfectly aligned. Accordingly, bilinear weights may be re-designed to correct for this.

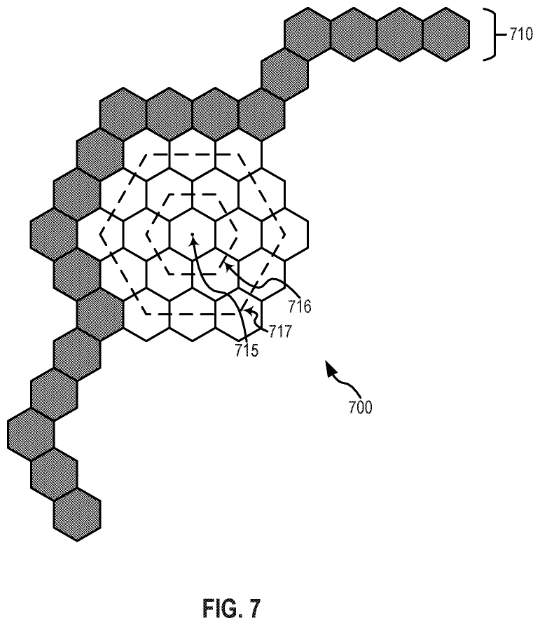

FIG. 7 shows an example of a hexagonal super-pixel PU shape 700 that supports intra-prediction for hexagonally-sampled compression and decompression of videos and images, in embodiments. In some examples, the hexagonal super-pixel PU shape 700 may be implemented by image processing device 250 and/or hexagonal-sampled video compression algorithm 215.

As shown in FIG. 7, the super-pixel PU shape 700 may be configured with various sizes, such as being configured as a smaller hexagon or as a larger hexagon, which mimics the idea of constructing a larger square pixel in HEVC. A parameter L may signify a number of levels of pixels to be used to denote the size of the hexagonal super-pixel. That is, the value for the number of levels L indicates a number of layers of hexagonal pixels surrounding one or more central pixels. For example, when L=1, the PU is a single hexagonal pixel; when L=2, there is another layer of pixels around the PU of L=1, such that the PU contains 7 pixels. Other PU sizes (e.g., including any number of levels L) can be calculated in a similar way. For instance, as shown in the example of FIG. 7, the hexagonal super-pixel PU shape 700 includes three levels: a first level 715, a second level 716, and a third level 717.

In the hexagonal super-pixel PU shape 700, pixels that are close to reference pixels 710 have a relatively better enclosure than that of square-sampled images. In some cases, however, hexagonal super-pixel PU shapes 700 may be arranged obliquely (e.g., at an angle with respect to one another), and another addressing scheme may be needed to appropriately access the pixels. Additionally, in some examples, the hexagonal super-pixel PU shape 700 may require a larger area to be padded to predict the boundary PUs. To remedy one or both of these considerations, one or more of (or multiples and/or combinations of) a number of variations of the hexagonal super-pixel PU shape 700 may be used.

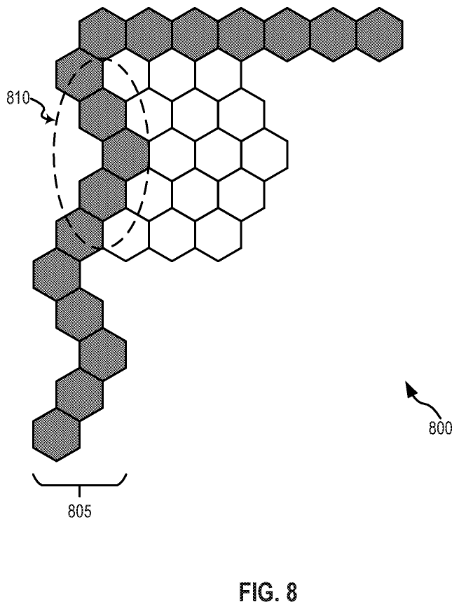

FIG. 8 shows an example of an arrow PU shape 800 that supports intra-prediction for hexagonally-sampled compression and decompression of videos and images, in embodiments. In some examples, the arrow PU shape 800 may be implemented by image processing device 250 and/or hexagonal-sampled video compression algorithm 215 of FIG. 2.

Arrow PU shape 800 is derived from a regular hexagonal super-pixel PU shape described in FIG. 7. For example, to provide the PUs a capability to slide over an image in a similar manner to a conventional raster scan, some pixels of the regular hexagonal super-pixel PU may be removed to deviate from the structure of a regular hexagonal super-pixel PU and form arrow PU shape 800. As illustrated by example of FIG. 8, a number of pixels are removed from the left side (in the area indicated by dashed ellipse 810) of a regular hexagonal super-pixel PU to create arrow PUT shape 800, where the arrow PUT shape 800 includes at least one inverted vertex (in the area of dashed ellipse 810) as compared to the corresponding portion of the regular hexagonal super-pixel PU shape, which has a convex vertex at the same relative location (e.g., the inverted vertex in the area of dashed ellipse 810 of the arrow PU shape 800 is concave, while the corresponding portion of the regular hexagonal super-pixel PU shape 700 is convex).

Arrow PU shape 800 is a recurring shape that may be applied in a conventional raster scan manner (e.g., in a direction parallel to rows) without overlap between consecutive arrow PU shapes 800. That is, arrow PU shape 800 may be tiled (or, e.g., tessellated—that is, arranged in a line without overlapping and without gaps between each arrow PU shape 800). This configuration may be used to perform a raster scan of an image in a manner similar to conventional techniques (e.g., using rectangular sampling techniques), for example, performing the raster scan along a sequence of parallel (or substantially parallel) scan lines.

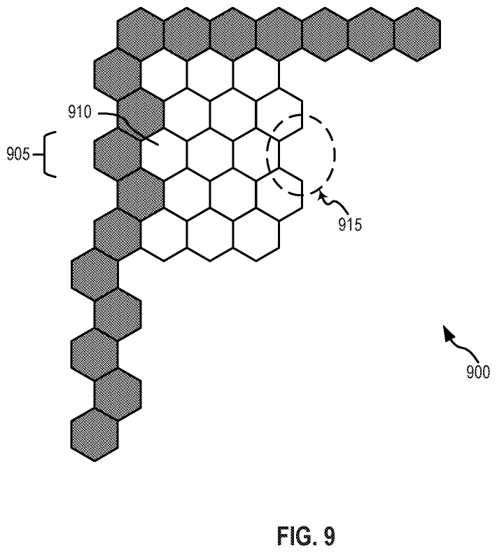

FIG. 9 shows an example of a rectangular zigzag PU shape 900 that supports intra-prediction for hexagonally-sampled compression and decompression of videos and images, in embodiments. As evident from FIG. 9, the rectangular zigzag PU shape comprises a number of adjacent equal-length rows. Generally, the number of rows may be different from the length of each row. In some examples, the rectangular zigzag PU shape 900 may be implemented by image processing device 250 and/or hexagonal-sampled video compression algorithm 215.

Rectangular zigzag PU shape 900 is derived from the arrow PU shape 800 shown in FIG. 8 (and is thus also derived from regular hexagonal super-pixel PU shape 700 of FIG. 7). For example, at a middle row 905 of the rectangular zigzag PU shape 900, one or more left-part pixels 910 are used, rather than right-part pixels 915, for example. As shown in the example of FIG. 9, the rectangular zigzag PU shape 900 does not include any pixels at the location 915 at the right (where the arrow PU shape 800 does include a pixel). Instead, the rectangular zigzag PU shape 900 includes a pixel 910 at the left. This provides the rectangular zigzag PU shape 900 with relatively more uniform, distributed edges, relative to the arrow PU shape 800 described in FIG. 8. As compared to the square zigzag PU shape 600 described in FIG. 6, the rectangular zigzag PU shape 900 includes an odd number of rows, whereas the square zigzag PU shape 600 includes an even number of rows.

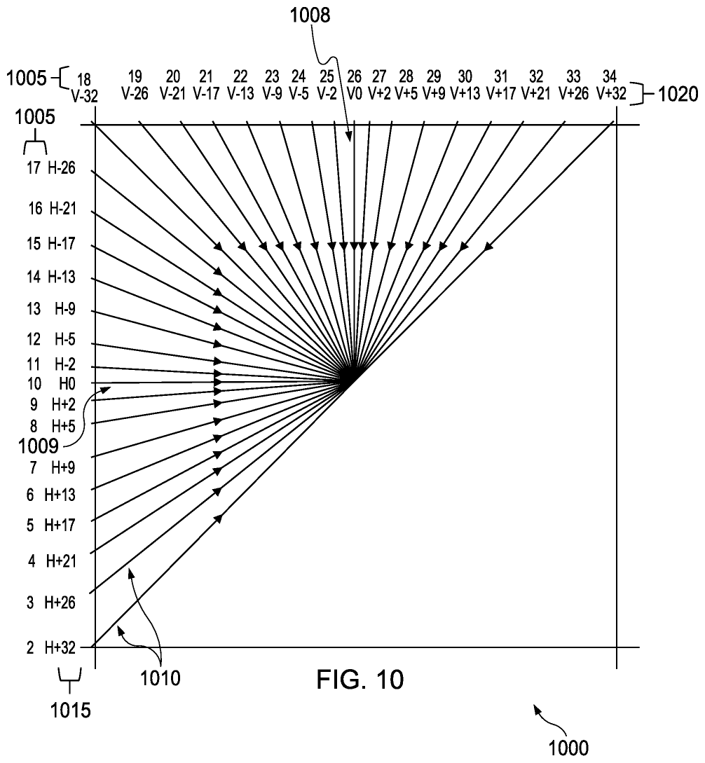

FIG. 10 is a diagram 1000 illustrating angular prediction modes 1005 for deriving a prediction for intra-prediction for square-sampled compression and decompression of videos and images. For benchmarking (e.g., for a fair comparison) hexagonal-sampled video compression algorithm 215 of FIG. 2 against the known HEVC intra-prediction technique, equal-angle modes similar to those shown in diagram 1000 are derived for parallelogram PU shape 500 of FIG. 5.

Generally, intra-prediction (which may also be referred to as “intra-picture prediction”) uses the previously decoded boundary samples from one or more spatially neighboring blocks (e.g., “boundary” samples referring to samples obtained at an edge of their respective blocks) to predict new values for a PU. The previously decoded samples that are used for a current iteration of intra-prediction may be referred to as “reference samples,” for example, obtained for corresponding “reference pixels.” As such, a first frame of a video sequence and a first image of a sequence of an image sequence may be coded using via intra-picture prediction (e.g., not in conjunction with another additional procedure). In HEVC, larger picture sizes provide an increased range of supported coding block sizes, while a number of directional orientations is also increased. FIG. 10 denotes a number of such directional orientations as directional orientations 1010.

Accordingly, HEVC supports a number of different intra-prediction modes, such as a planar mode (e.g., a “Mode 0”), a DC (flat) mode (e.g., a “Mode 1”), and/or one or more angular modes (e.g., “Mode 2” through “Mode 35”). The different angular modes correspond to respective ones of the number of different directional orientations 1010 (e.g., 33 different directional orientations 1010). The directional orientations 1010 refer to the direction of a reference pixel with respect to the sample. In FIG. 10, the example representation 1000 indexes the angular prediction modes 1005 between two indices corresponding to respective directional orientations 1010 (e.g., HEVC indexing 33 angular modes 1005 from 2 to 34). That is, each different angular prediction mode 1005 corresponds to one of a number of different respective directional orientations 1010 (e.g., where there is a 1:1 correspondence between angular prediction modes 1005 and corresponding directional orientations 1010).

The objective of the benchmark is to derive a prediction with a minimum number of modifications of an existing test mode (e.g., existing HEVC test mode implementations). Each angular prediction mode 1005 has an associated displacement parameter d, where the value for d indicates a numeric part representing the pixel's displacement relative to another pixel (e.g., where the displacement d may be expressed as a multiple of 1/32 pixels), for example, each angular prediction mode 1005 being defined by an offset with respect to a vertical pixel 1008 (or a substantially vertical pixel, e.g., a sample at a reference pixel having no or substantially no horizontal offset from, and thus being in a vertical line with, the pixel being predicted, as shown in FIG. 10 as the vertical pixel 1008 at VO) or a horizontal pixel 1009 (or a substantially horizontal pixel, e.g., a sample at a reference pixel having no or substantially vertical offset from, and thus being in a horizontal line with, the pixel being predicted, as shown in FIG. 10 as the horizontal pixel 1009 at HO). In FIG. 10, H and V indicate the horizontal and vertical directionalities along the horizontal and vertical axes, respectively. According to their respective values of H and V, different directional orientations 1010 may cover angles from near-horizontal or pure-horizontal prediction (e.g., as shown in FIG. 10 at angular prediction 10) through near-diagonal (e.g., as shown in FIG. 10 at angular prediction 18) to near-vertical or pure vertical prediction (e.g., as shown in FIG. 10 at angular prediction 26).

Accordingly, for any particular sample (e.g., of a rectangular sample in HEVC, or as described herein, of a hexagonal sample) of a PU, the directional orientation 1010 (e.g., as shown by each of the arrows in FIG. 10) of a respective angular mode 1005 may be used to extrapolate and/or interpolate a sample from one or more reference samples (e.g., neighboring pixels).

For consistency with HEVC, a first variable or parameter, predModeIntra, denotes the angular prediction modes 1005 (or, e.g., another intra prediction mode), and a second variable or parameter, intraPredAngle, refers to the offset to the horizontal pixel or the vertical pixel (e.g., in a reference column 1015 and a reference row 1020, respectively).

An example table of predicted values for the first parameter (e.g., predModeintra) and the second parameter (e.g., intraPredAngle) is provided below.

| | predModeIntra | | | | | | | | | | |
|---|---|---|---|---|---|---|---|---|---|---|---|
| | 2 | 3 | 4 | 5 | 6 | 7 | 8 | 9 | 10 | 11 | 12 |
| intraPredAngle | 32 | 26 | 21 | 17 | 13 | 9 | 5 | 2 | 0 | −2 | −5 |

| | predModeIntra | | | | | | | | | | |
|---|---|---|---|---|---|---|---|---|---|---|---|
| | 13 | 14 | 15 | 16 | 17 | 18 | 19 | 20 | 21 | 22 | 23 |
| intraPredAngle | −9 | −13 | −17 | −21 | −26 | −32 | −26 | −21 | −17 | −13 | −9 |

| | predModeIntra | | | | | | | | | | |
|---|---|---|---|---|---|---|---|---|---|---|---|
| | 24 | 25 | 26 | 27 | 28 | 29 | 30 | 31 | 32 | 33 | 34 |
| intraPredAngle | −5 | −2 | 0 | 2 | 5 | 9 | 13 | 17 | 21 | 26 | 32 |

To obtain these values, for example, samples having angular modes 1005 between 2 and 17 may project samples located in the row above themselves as additional samples (e.g., as shown in the left-hand reference column 1015), which may then be used to extend the reference column 1015. Likewise, samples having angular modes 1005 between 18 and 24 may project samples located in the row to the left of themselves as additional samples (e.g., as shown in the top reference row 1020), which may then be used to extend the reference row 1020. Once the reference samples are known, samples may be predicted by projecting their respective locations onto respective reference samples and applying the selected prediction direction.

For purposes of benchmarking, image processing device 250 and/or hexagonal-sampled video compression algorithm 215 determines, for each given reference pixel, one angular prediction mode that has the same or similar angle to HEVC test mode implementations, for example, as illustrated in FIG. 10.

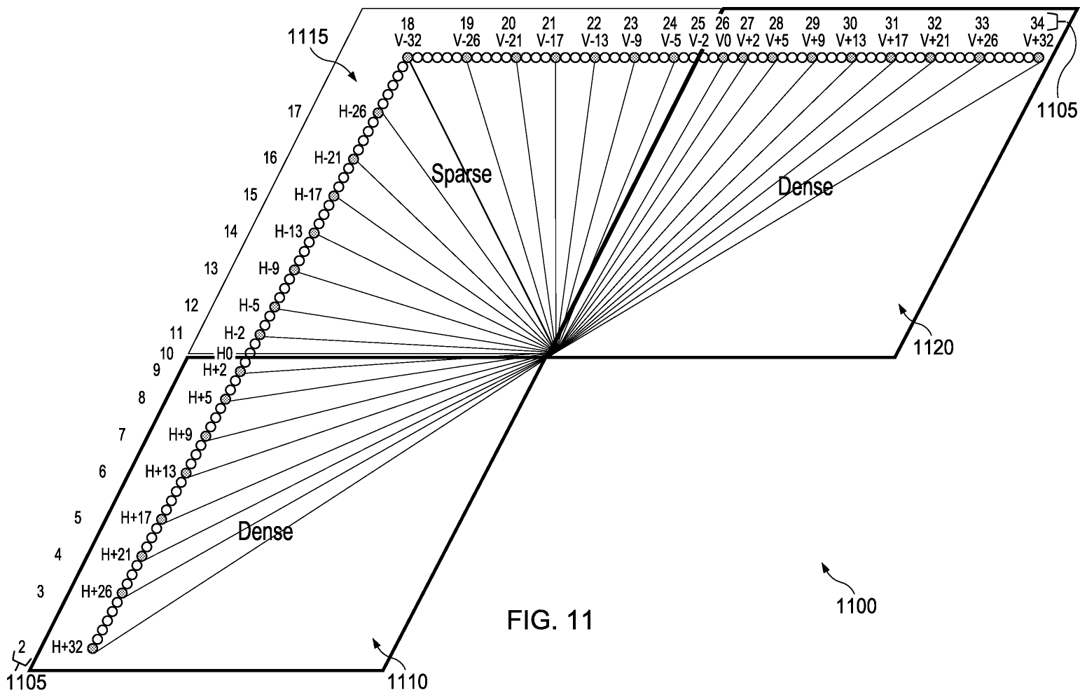

FIG. 11 is a diagram 1100 illustrating angular prediction modes 1105 corresponding to angular prediction modes 1005 of FIG. 10 as directly applied to parallelogram PU shape 500 of FIG. 5.

Diagram 1100 shows that the angles between the modes are not uniform. That is, the angular prediction modes 1105 are not uniformly allocated over the illustrated 180 degrees. For example, diagram 1100 include a dense region 1110 for angular prediction modes 1105 in the range of mode 2 through mode 10, a sparse region 1115 for angular prediction modes 1105 in the range of mode 10 through mode 25, and another dense region 1110 fir angular prediction modes 1105 in the range of mode 25 through mode 34.

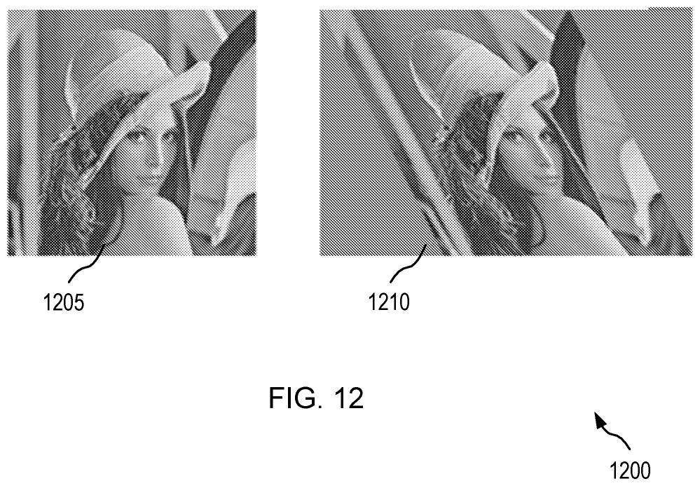

FIG. 12 shows a representation of a non-shifted hexagonally-sampled image 1205 and a representation of a forward shifted image 1210 that facilitates pixel addressing by conventional HEVC implementations.

This shifting procedure is used to rearrange hexagonally-sampled image pixels in a more accessible way, for example, to facilitate a pixel addressing by conventional HEVC implementations. The forward shifting process causes each row of the non-shifted hexagonally-sampled image to shift by a pixel distance Δ, to generate forward shifted image 1210, where

$$\\ Δ = ⌈ \frac{y}{2} ⌉ , y = 0 , 1 , … , {h}_{h} - 1 ,$$

and hₕ is the height of the hexagonally-sampled image. In some embodiments, the forward shifting process is not used when an alternative addressing scheme is developed to access the correct reference pixels. However, by applying the forward shifting process as described herein, the forward shifted image 1210 may be directly used with other HEVC test mode implementations to derive its results (e.g., being equal to those of the benchmark). The shifting process is lossless and does not affect performance of intra prediction, but makes the hexagonal-sampled image compatible with conventional HEVC implementations such that the reference pixels are correctly accessed.

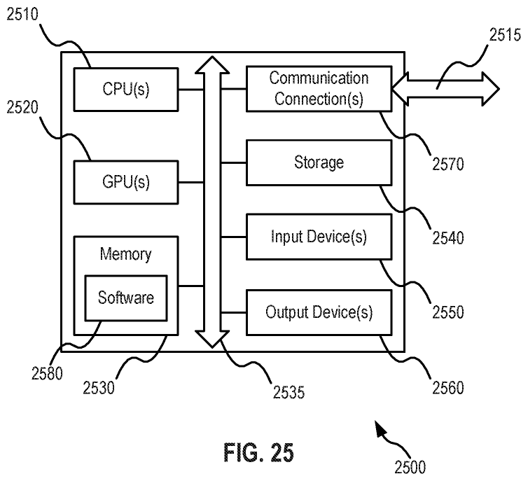

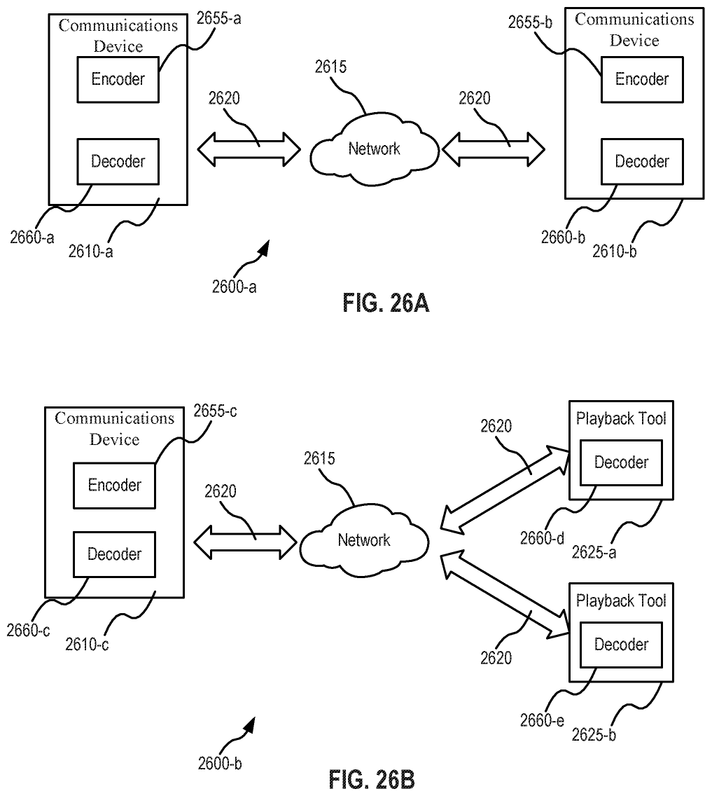

In some examples, a device including a decoder (e.g., a decoding device, as is further described in FIGS. 25, 26A, and 26B) performs a de-shifting procedure to rearrange at least a portion of the hexagonally-sampled image. The de-shifting procedure may be an inverse operation to the shifting procedure described above or, alternatively, may be performed independently of a prior shifting procedure (or the lack thereof). Like the shifting procedure described herein, the de-shifting procedure may facilitate a pixel addressing process. In some examples, the de-shifting causes each row of the hexagonally-sampled image to shift by a pixel distance −Δ, an equal and opposite shift to that of the shifting procedure described above. After performing the de-shifting procedure, the device generates a PU based on the de-shifting procedure (e.g., according to rearranged data obtained by way of the de-shifting procedure).

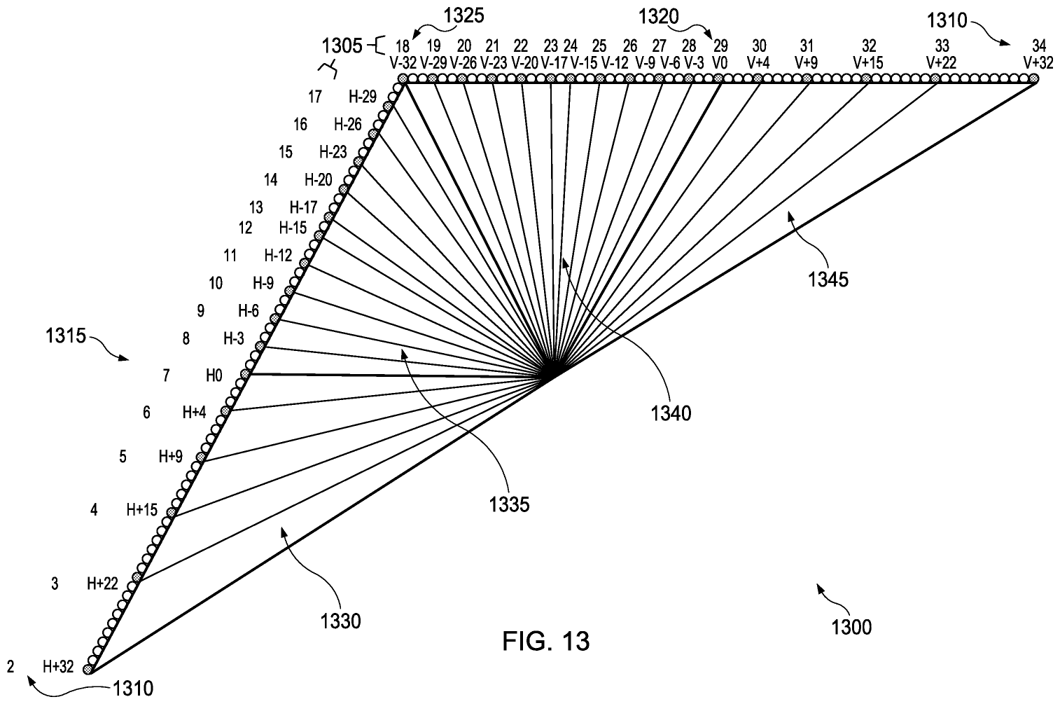

FIG. 13 shows an example representation 1300 of equal-angle prediction modes 1305 for parallelogram PU shape 500 of FIG. 5. Unlike angular prediction modes 1105 of FIG. 11, angular prediction modes 1305 have equal angular spacing, and include five primary intra-prediction modes 2, 7, 18, 29 and 34 designated as primary intra-prediction modes. In certain embodiments, angular predictions modes 1305 may be implemented by image processing device 250 and/or hexagonal-sampled video compression algorithm 215 of FIG. 2. Modes 2 and 34 are designated as boundary prediction modes 1310, modes 7 and 29 being a horizontal prediction mode 1315 and a vertical prediction mode 1320, respectively, and mode 18 being a diagonal prediction mode 1325. It should be noted that the vertical mode is not spatially vertical, but fulfils the condition wherein the horizontal offsets from the left reference pixels are equal.

The designated five primary intra-prediction modes divide equal-angle prediction modes 1305 into four uniformly divided zones 1330, 1335, 1340, and 1345. The four zones are divided uniformly and rounded to a nearest pixel locations. As used herein, zone 1330 may be called “Zone 1” and encloses mode 2 through mode 7; zone 1335 may be called “Zone 2” and encloses mode 7 through mode 18; zone 1340 may be called “Zone 3” and encloses mode 18 through mode 29; and zone 1345 may be called “Zone 4” and encloses mode 29 through mode 34.

Accordingly, angles may be relatively evenly distributed between a total of 33 modes, subject to the five primary prediction directions being fixed. Accordingly, if all the 33 modes are uniformly distributed across a 180° angle, the angle between two neighboring angular modes may be given by

$$δ = \frac{180 °}{32} .$$

By solving the resulting triangle, the angle between modes 7 and 2 is determined to be 30°, which is the same as the angle between modes 29 and 34.

Therefore, the first zone 1330 (Zone 1) spans a spanning angle of 30°, the second zone 1335 (Zone 2) spans a spanning angle of 60°, and the third zone 1340 (Zone 3) spans a spanning angle of 600, and the fourth zone 1345 (Zone 4) spans a spanning angle of 30°. In some examples, φ may be used to denote these spanning angles for the respective zones, that is, where:

φ₁=30°

φ₂=60°

φ₃=60°

φ₄=30°.

In some examples, a number of angular prediction modes in each zone (e.g., excluding boundary angular modes) may be calculated with the following equation:

$${n}_{i} = round ( \frac{{φ}_{i}}{δ} ) .$$

After nᵢ is derived, each zone is divided with the equally distributed angles and rounded to the closest integer location reference pixels. This provides updated values for the first parameter (e.g., predModeIntra) and the second parameter (intraPredAngle) as shown in the table below.

| | predModeIntra | | | | | | | | | | |
|---|---|---|---|---|---|---|---|---|---|---|---|
| | 2 | 3 | 4 | 5 | 6 | 7 | 8 | 9 | 10 | 11 | 12 |
| intraPredAngle | 32 | 22 | 15 | 9 | 4 | 0 | −3 | −6 | −9 | −12 | −15 |

| | predModeIntra | | | | | | | | | | |
|---|---|---|---|---|---|---|---|---|---|---|---|
| | 13 | 14 | 15 | 16 | 17 | 18 | 19 | 20 | 21 | 22 | 23 |
| intraPredAngle | −17 | −20 | −23 | −26 | −29 | −32 | −29 | −26 | −23 | −20 | −17 |

| | predModeIntra | | | | | | | | | | |
|---|---|---|---|---|---|---|---|---|---|---|---|
| | 24 | 25 | 26 | 27 | 28 | 29 | 30 | 31 | 32 | 33 | 34 |
| intraPredAngle | −15 | −12 | −9 | −6 | −3 | 0 | 4 | 9 | 15 | 22 | 32 |

Prediction using zigzag-square PU shape 600 of FIG. 6 is similar to conventional square-image prediction; however, pixels of zigzag-square PU shape 600 are not vertically aligned, and thus left reference pixels of the zigzag-square PU shape exhibit a zigzag pattern. A planar mode for zigzag-square PUT shape 600 may use up to three directional predictions: horizontal, a 60° axis interpolation, and a 120° axis interpolation, whereas twvo-direction prediction is used for a square-sampled image planar mode. In some examples, the planar mode may handle prediction for PUs for which prediction may be difficult according to other techniques (e.g., PUs with sides that have zigzag patterns).

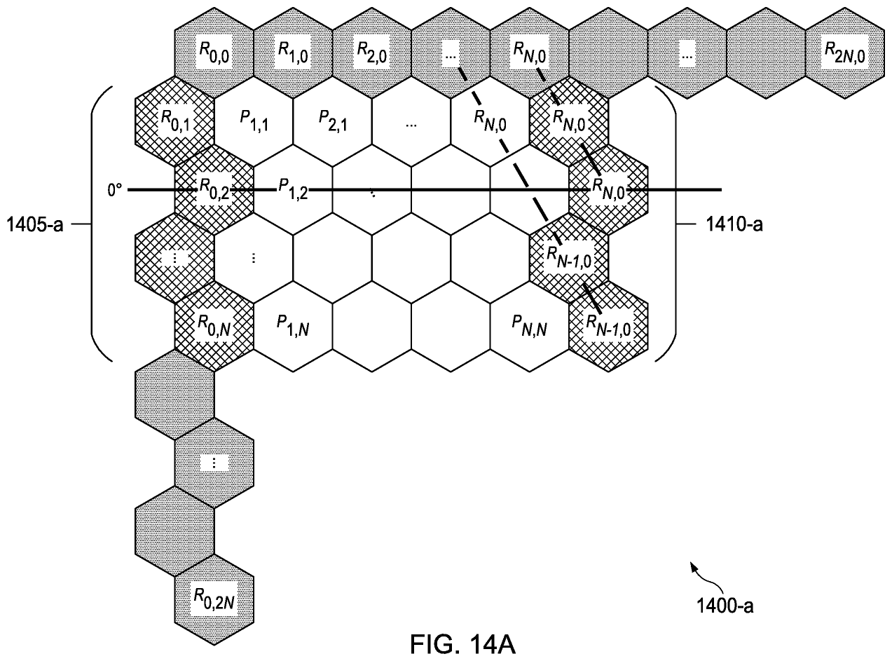

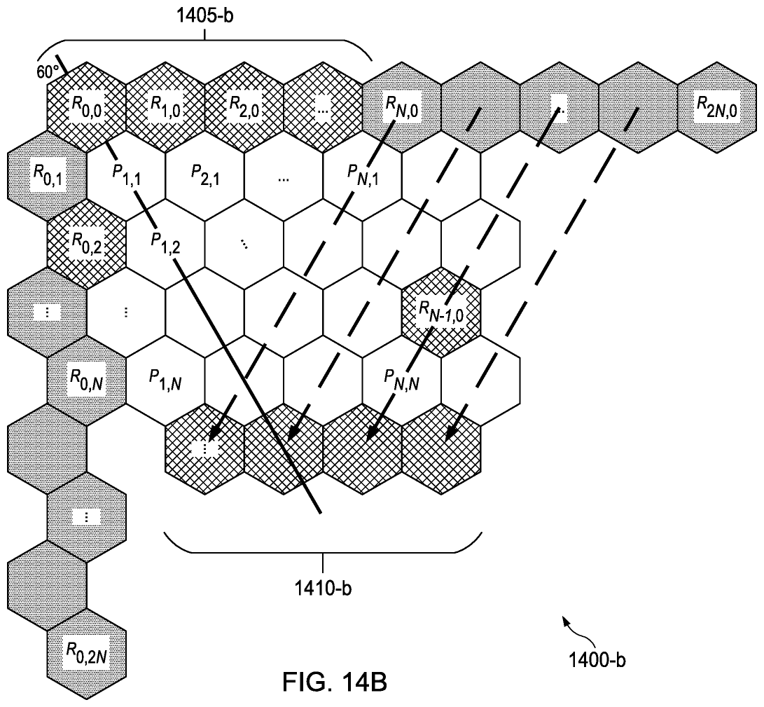

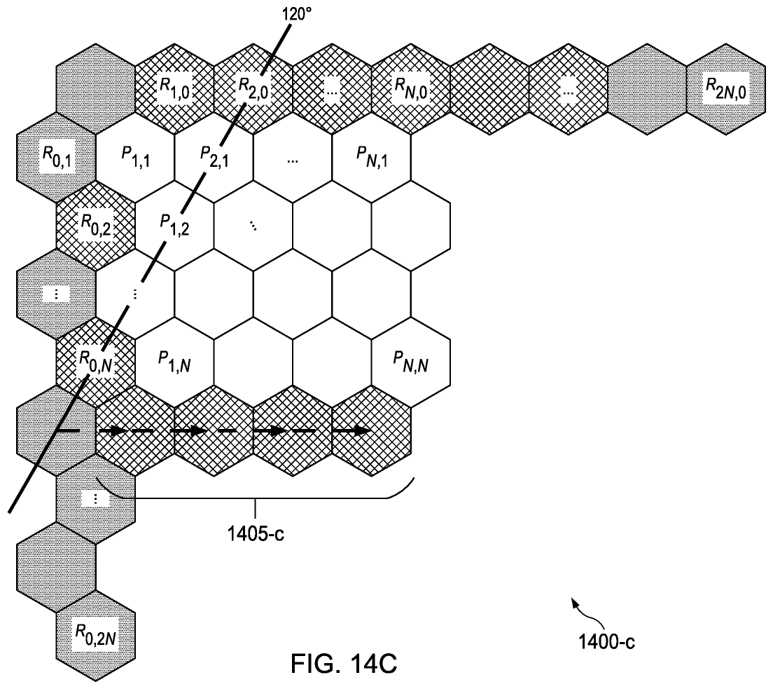

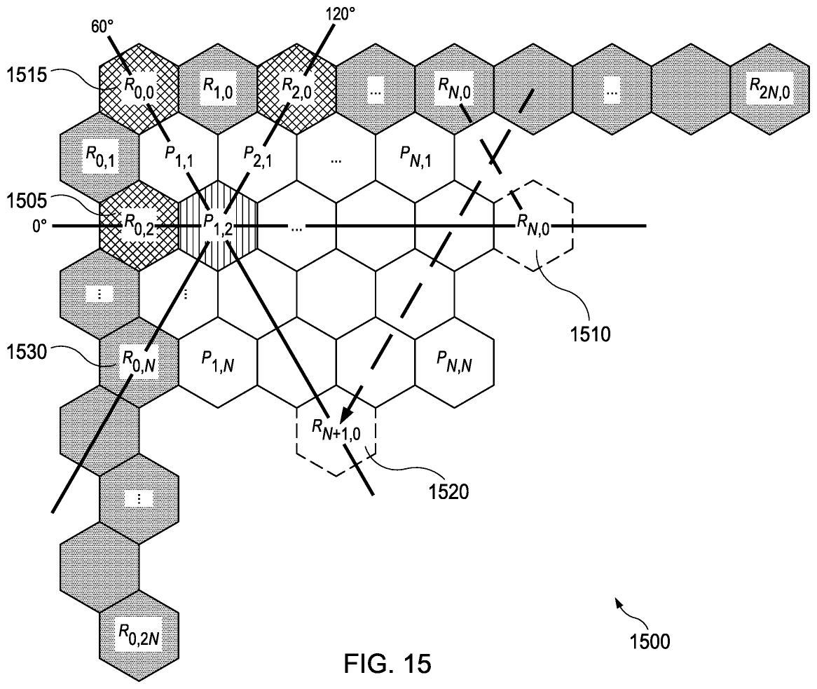

FIGS. 14A, 14B, and 14C show reference pixels for three directional planar mode interpolations 1400-a, 1400-b, and 1400-c for zigzag-square PU shape 600 of FIG. 6, in embodiments. FIG. 15 shows a generalization of rules for selecting reference pixels for the three directions of the planar mode interpolations of FIGS. 14A, 14B, and 14C. FIGS. 14A, 14B, 14C, and 15 are best viewed together with the following description. For example, FIG. 14A shows reference pixels for a first directional planar mode interpolation 1400-a for performing a horizontal interpolation of a value for a pixel; FIG. 14B shows reference pixels for a second directional planar mode interpolation 1400-b for performing a 600 axis interpolation of the value for the pixel; and FIG. 14C shows reference pixels for a third directional planar mode interpolation 1400-c for performing a 120° axis interpolation of the value for the pixel. In certain embodiments, the directional planar mode interpolations 1400-a, 1400-b, 1400-c and 1500 of FIGS. 14A, 14B, 14C, and 15 may be implemented by image processing device 250 and/or hexagonal-sampled video compression algorithm 215 of FIG. 2.

The three-directional planar mode interpolations 1400-x shown in FIGS. 14A, 14B and 14C show the general rules for selecting reference pixels 1405-x for each of one or more axes. For example, when performing the directional planar mode interpolation for a horizontal axis, a first reference pixel is taken from the left side, for example, at 1405-a, and a second reference pixel is copied from the 60° direction at 1410-a. When performing the directional planar mode interpolation for the 60° axis, a first reference pixel from the 600 direction at 1405-b and a second reference pixel are copied from the 120° direction at 1410-b. Similarly, when performing the directional planar mode interpolation for the 120° axis, a first reference pixel from the 120° direction at 1405-c and a second reference pixel are copied from a horizontal direction, also at 1405-c. A final predicted interpolated pixel value may then be obtained by averaging the three predicted values from each of the three axes (i.e., by averaging the predicted values for the horizontal axis, the 60° axis, and the 1200 axis).

The example zigzag square prediction scheme 1500 shown in FIG. 15 includes three axes: a horizontal axis for a horizontal interpolation, a 60° axis for a 60° axis interpolation, and a 120° axis for a 120° axis interpolation. In some examples, the planar mode for a zigzag square prediction scheme 1500 of FIG. 15 may be implemented for intra-prediction by an image sensor in any device, such as a camera or other device including a camera (e.g., a phone, or other UE or communications device) that may capture a real-world scene using a hexagonal grid of sensors. The device may additionally or alternatively include computer hardware, such as a processor, memory, an encoder and/or decoder, and other like hardware).

The final predicted value is the average of the predicted values obtained from each of the three axes, as is similarly described in FIGS. 14A-C. Here, in the example zigzag square prediction scheme 1500 shown illustratively in FIG. 15, from the pixel P_{1,2}, as an example, the following interpolated values will be first derived. For the horizontal axis: R_{0,2} (1505) and R_{N,0} (1510) are used to perform bilinear interpolation \hat{P}_{1,2}^{0°}. Along the 60° axis: R_{0,0} (1515) and R_{N+1,0} (1520) are used to perform bilinear interpolation \hat{P}_{1,2}^{60°}. Along the 120° axis: R_{2,0} (1525) and R_{0,N} (1530) are used to perform bilinear interpolation \hat{P}_{1,2}^{120°}. Then, by averaging the predicted values, the final predicted value is the average of the three interpolated values:

$${P}_{1 , 2} = \frac{{\hat{P}}_{1 , 2}^{0 °} + {\hat{P}}_{1 , 2}^{60 °} + {\hat{P}}_{1 , 2}^{120 °}}{3} .$$

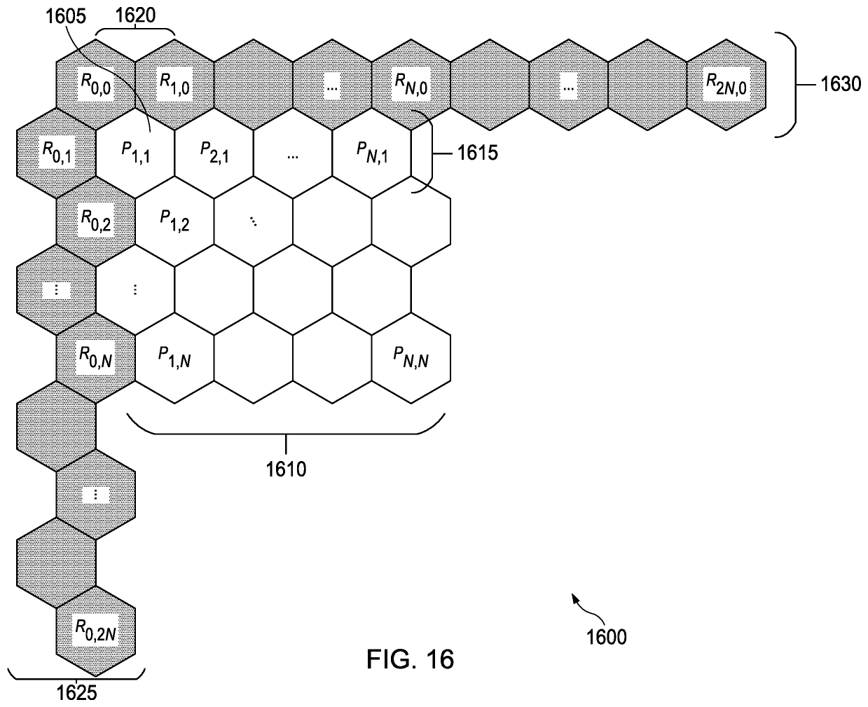

FIG. 16 shows a DC mode of a zigzag square prediction scheme 1600 that supports intra-prediction for hexagonally-sampled compression and decompression of videos and images, in embodiments. In certain embodiments, the DC mode for the zigzag square prediction scheme 1600 of FIG. 16 may be implemented by image processing device 250 and/or hexagonal-sampled video compression algorithm 215 of FIG. 2.

According to the DC mode for the zigzag square prediction scheme 1600, a first DC value is derived, according to:

$$dcVal = ( {\sum }_{x = 1}^{N} {R}_{x , 0} + {\sum }_{y = 1}^{N} {R}_{0 , y} + N ) ≫ ( {log}_{2} ( N ) + 1 ) .$$

A first pixel (e.g., the top-left pixel 1605) collects an average from each of, for example, four neighbor pixels 1610, according to:

P_{1,1}=(R_{0,2}+R_{0,1}+R_{0,0}+R_{1,0}+2)>>2.

Each top row pixel 1615 takes the average from its two nearest neighbor pixels 1610.

P_{x,1}=(R_{x-1,0}+R_{x,0}+2·dcVal+2)>>2.

Each left column pixel 1620 takes the average of either one left neighbor or three left neighbor pixels 1610. Then, the left column pixel 1620 can average the values of the even rows, according to:

P_{1,y}=(R_{0,y}+3·dcVal+2)>>2. Even row:

Finally, the left column pixel 1620 can average the values of the odd rows, according to:

P_{1,y}=(R_{0,y-1}+R_{0,y}+R_{0,y+1}+dcVal+2)>>2 Odd row:

In certain embodiments, the native DC mode is improved according to two additional or alternative concepts. First, because the spanning distances of the left reference pixels 1620 and top reference pixels 1630 (e.g., having a ratio of \sqrt{3}:2) are not equal, a value (e.g., dcVal) can be derived by adding a weight (e.g., similar to bilinear filter weights described below) to the left reference pixels 1625 and the top reference pixels 1630. These weights may be inversely proportional to the distance the reference pixel is from the predicted pixel.

Additionally, or alternatively, odd rows of the first column 1625 and the top row 1630 may have more than one reference pixel each. The neighboring reference pixels should have more correlations than the parameter dcVal. As such, these predicted values may be derived only with the neighboring reference pixels without incorporating the parameter dcVal.

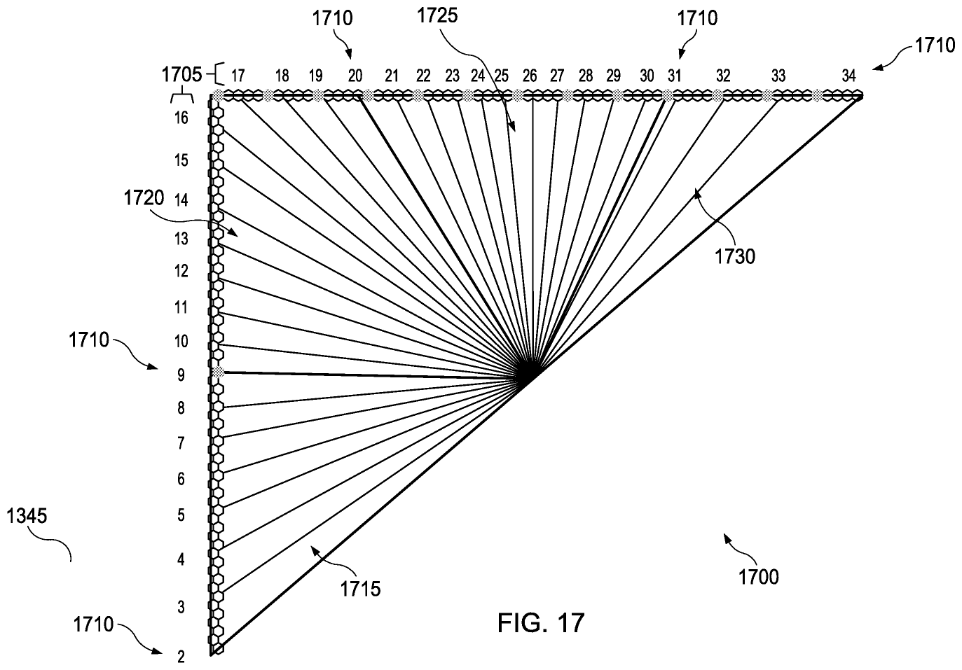

FIG. 17 is a diagram 1700 illustrating example angular prediction modes 1705 for zigzag-square PU shape 600 of FIG. 6, in embodiments. Use of angular prediction modes 1705 includes two steps: first, finding reference pixels; and second, finding one or more weighting factors for interpolation (e.g., bi-linear interpolation). In certain embodiments, angular prediction modes 1705 may be implemented by image processing device 250 and/or hexagonal-sampled video compression algorithm 215 of FIG. 2.

As similarly described for FIG. 13, five angular prediction modes 1705 (e.g., modes 2, 9, 20, 31 and 34) are designated as primary intra-prediction modes 1710. As shown, primary intra-prediction modes 1710 include: modes 2 and 34, which may be designated as boundary prediction modes; mode 9, which may be designated as a horizontal prediction mode; and modes 20 and 31 which may be designated as diagonal prediction modes.

The five primary intra-prediction modes 1710 demarcate four uniform zones 1715, 1720, 1725, and 1730. In certain embodiments, non-integer values may be rounded (e.g., to a nearest pixel locations). As shown in FIG. 17, a first zone 1715 may be called “Zone 1” and encloses mode 2 through mode 9; a second zone 1720 may be called “Zone 2” and encloses mode 9 through mode 20; a third zone 1725 may be called “Zone 3” and encloses mode 20 through mode 31; and a fourth zone 1730 may be called “Zone 4” and encloses mode 31 through mode 34.

In some implementations, hardware/software (e.g., image processing device 250 and/or hexagonal-sampled video compression algorithm 215 of FIG. 2) is configured to maintain weighting factors (e.g., bilinear weights) as accurately as possible. In some examples, an angle parameter (e.g., intraPredAngles) is stored as one or more floating numbers.

In certain embodiments, mode 9 is used as a baseline to define an angle associated with angular prediction mode 1705. The prediction modes under this baseline (e.g., modes 2 through 8) have negative angles and those above the baseline (e.g., modes 10 through 34) have positive angles. Therefore, an angle α associated a prediction mode predModeintra may be derived as follows.

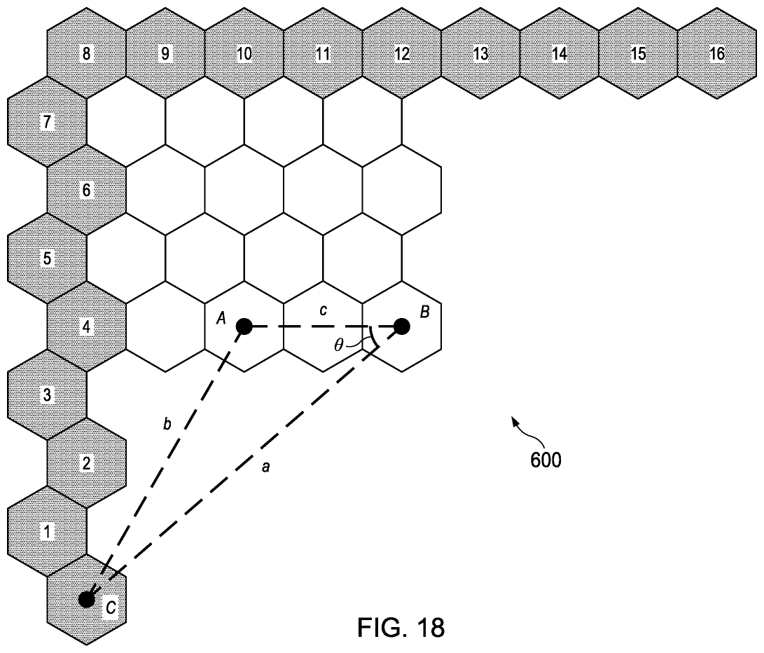

FIG. 18 shows zigzag-square PU shape 600 of FIG. 6 (e.g., an example of a 4×4 PU shape) and demonstrates how an angle between Mode 2 and Mode 9 (e.g., baseline horizontal mode) may be derived, and that the angle is the same for other PU sizes.

To determine an angle θ in a horizontal mode (e.g., Mode 2 and Mode 9, as described herein), a first line segment AC is determined in a direction of 120° from a first reference pixel at location C to a second reference pixel at location A to create line segment AC. Line segments AB and BC are also determined, where the line segment AB is horizontal and connects the second reference pixel at location A with a third reference pixel at location B, and the line segment BC connects the first reference pixel at location C with the third reference pixel at location B to form a triangle ABC that has the properties: line segment AB is horizontal, ∠A=120°, b=4, and c=2. With this information, the angle θ can be determined according to the laws of sine and cosine, for example:

$${a}^{2} = {b}^{2} + {c}^{2} - 2 bc \cdot cos A$$

$$\frac{a}{sin A} = \frac{b}{sin θ} .$$

Solving the triangle derives the angle

$$θ = {sin}^{- 1} \frac{2 \cdot \sqrt{3}}{\sqrt{28}} .$$

In the following procedure, we can find a value for the angle α according to a first parameter, predModeIntra, which is used to denote the angular prediction modes, and a second parameter (intraPredAngle), which refers to the offset to the horizontal pixel or the vertical pixel. These are then applied using the positive/negative properties described herein (e.g., based on being above or below the baseline).

$$if predModeIntra = 2 , α = - θ$$

$$else if predModeIntra = 9 , α = 0 °$$

$$else if predModeIntra = 20 , α = 60 °$$

$$else if predModeIntra = 31 , α = 120 °$$

$$else if predModeIntra = 34 , α = 180 ° - θ$$

$$else if predModeIntra < 9 , α = - θ + ( predModeIntra - 2 ) \times \frac{θ}{7}$$

$$else if predModeIntra < 31 , α = ( predModeIntra - 9 ) \times \frac{60 °}{11}$$

$$else α = 120 ° + ( predModeIntra - 31 ) \times \frac{60 ° - θ}{3}$$

With the angle α, we can find the intersection of the zigzag lines corrected by reference pixels and select two nearby reference pixels near the intersection point.

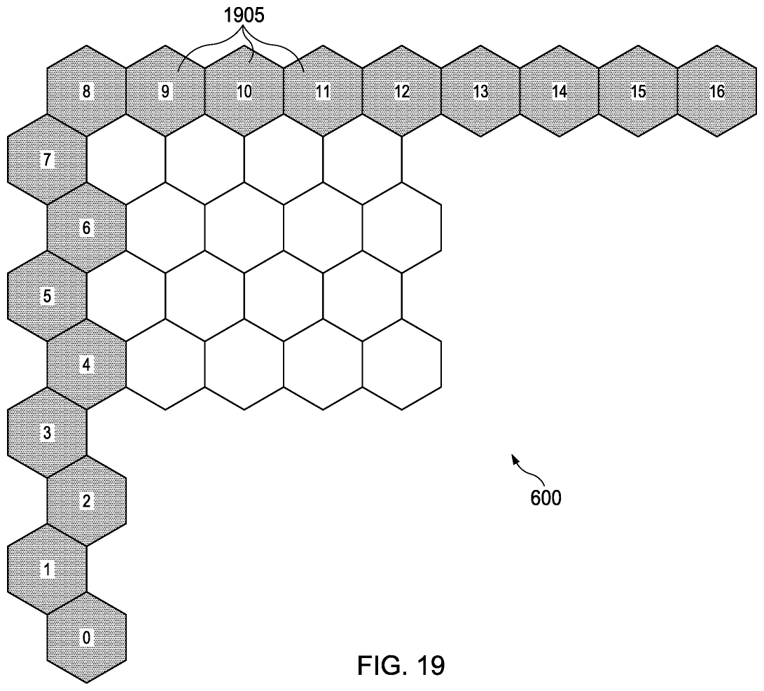

FIG. 19 shows zigzag-square PU shape 600 of FIG. 6 with several reference pixels 1905 to illustrate how weighting factors (e.g., filters and/or bilinear weights, etc.) are derived, in embodiments. To derive the bilinear weights, an angle α between a baseline and a given angular prediction mode is calculated. The angle α may be determined for each predicted pixel for any or all angular prediction modes before deriving bilinear weights to substantially accelerate the encoding process implemented by hexagonal-sampled video compression algorithm 215 for example. The reference pixels 1905 to the left of zigzag-square PU shape 600 are not vertically aligned, and therefore there is no uniform formula to characterize triangular relationships for these pixels. Accordingly, the following examples illustrate calculation of the triangular relationships for these pixels to determine its bilinear weight.

For clarity of illustration, as shown in FIG. 19, reference pixels 1905, reference pixels 1905 are sequentially indexed, starting with the bottom left reference pixel which is given an index of “0,” increasing the index by one for each reference pixel towards the top-left corner, and continue towards the top-right reference pixel which received the index of “16,” which is 4N since zigzag-square PU shape 600 may be defined as an N×N PU where N is 4. In the following description, ref1 and ref2 denote first and second reference pixel indices, where ref1≤ref2, and angles are determined by connecting each reference pixel with a current predicted pixel. Accordingly, two reference pixels are quickly identified, given an angular mode.

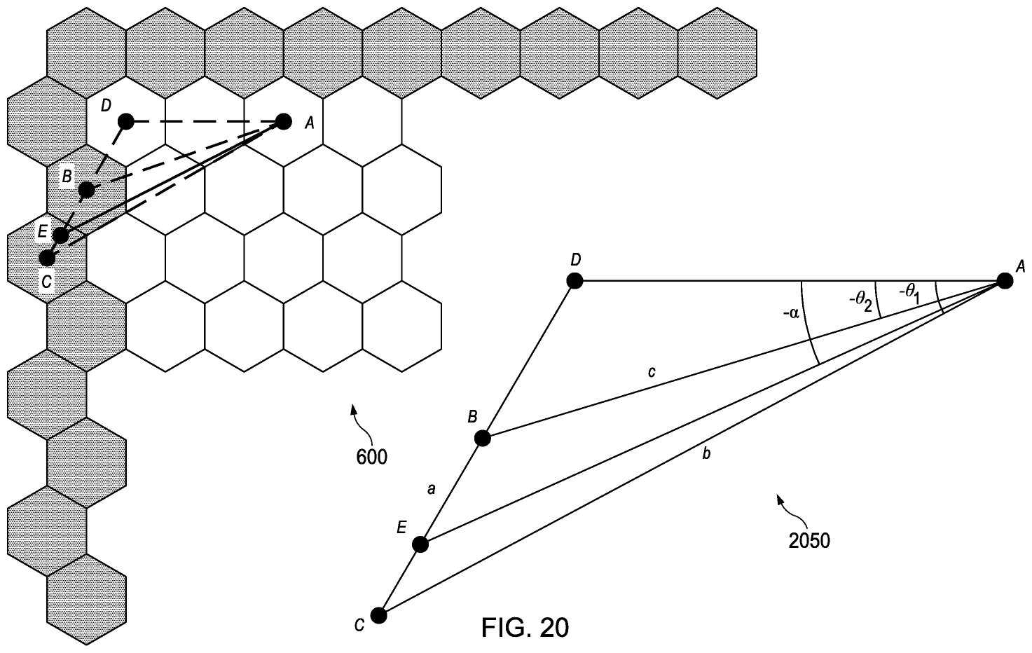

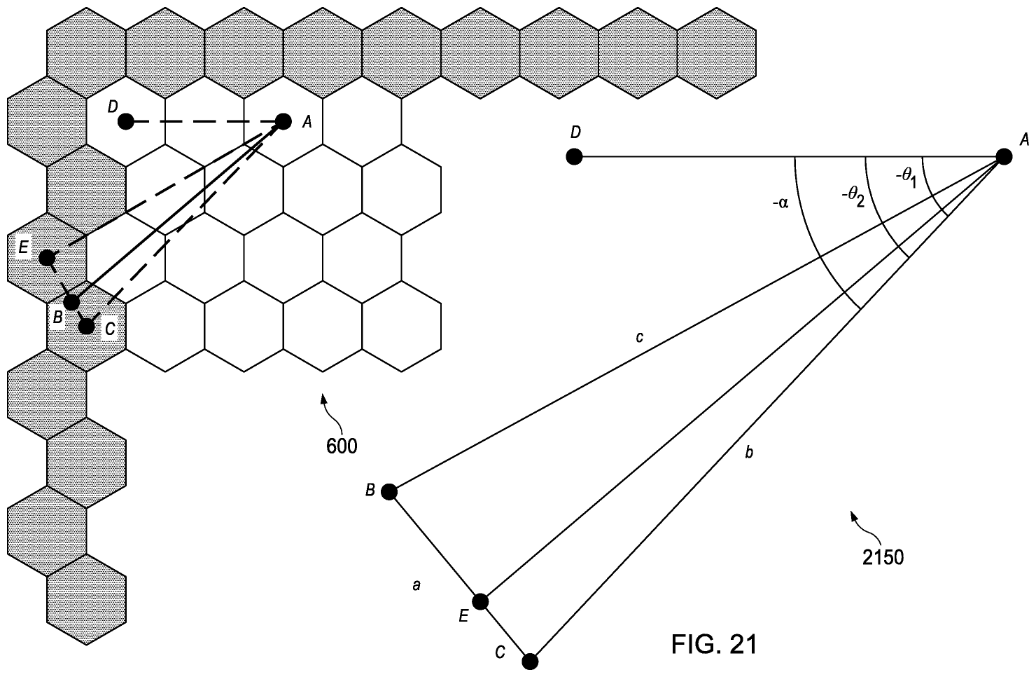

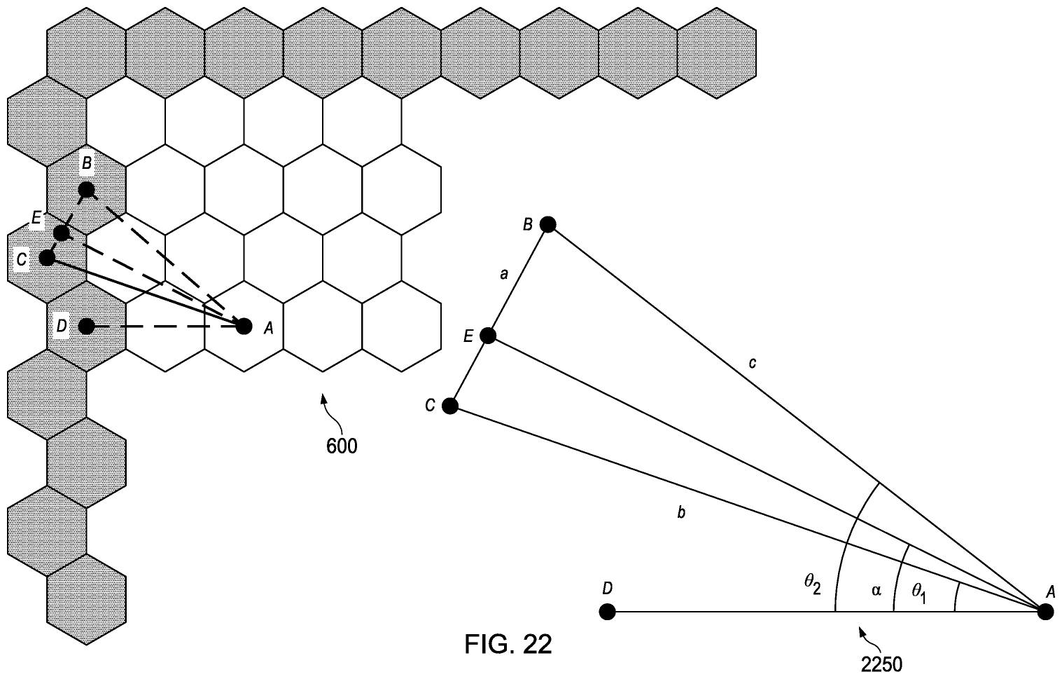

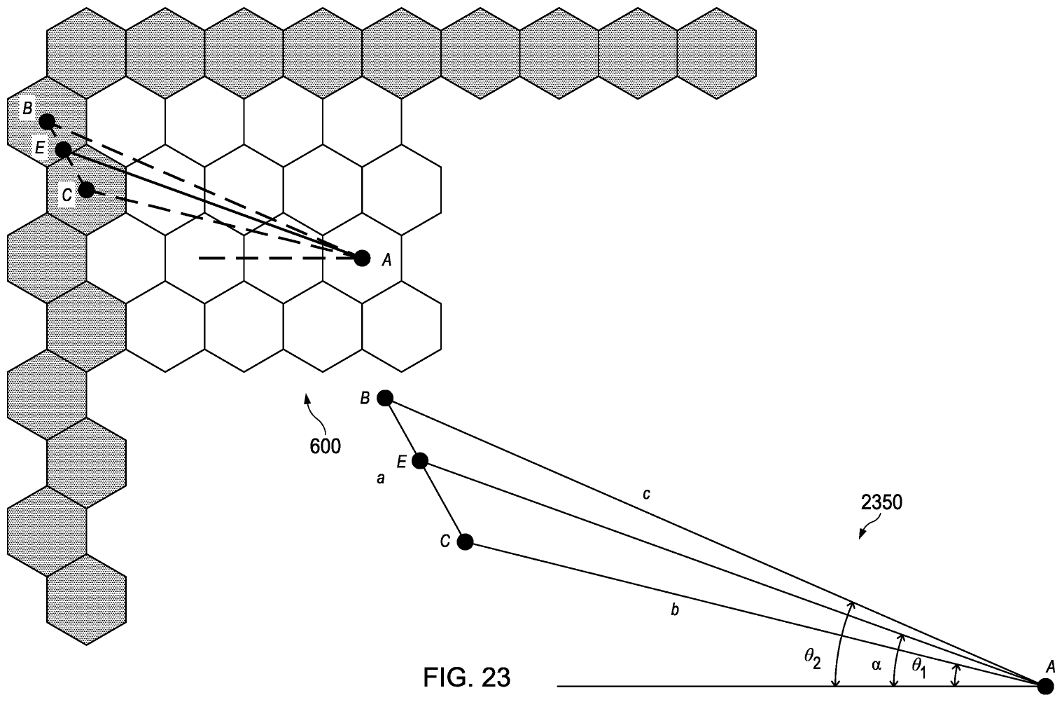

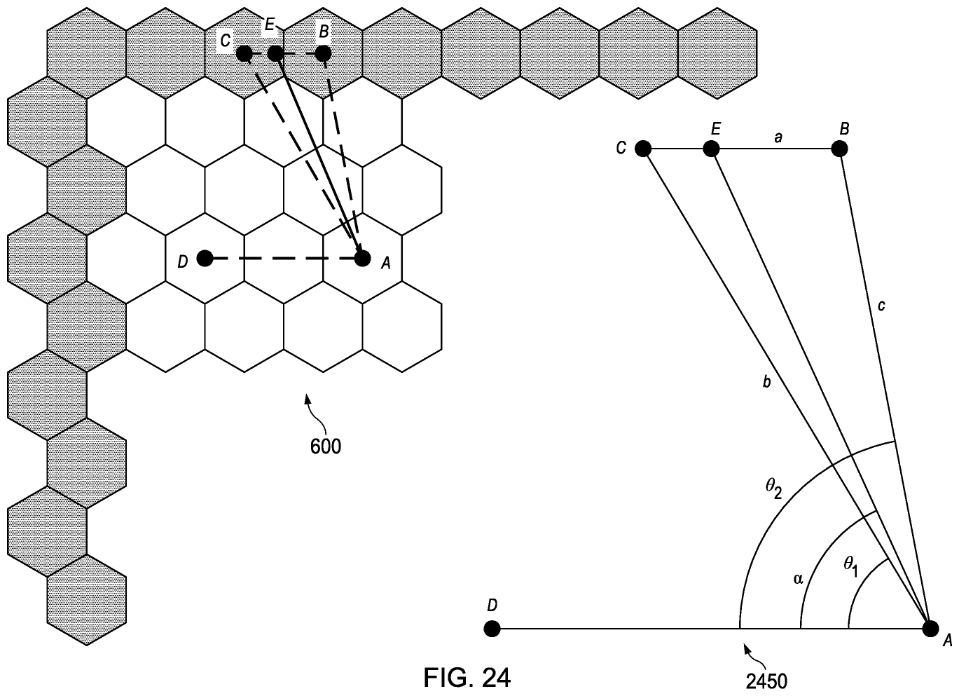

To calculate bilinear weights, five different calculations are used, as shown in FIGS. 20-24, and described below. A first calculation shown in FIG. 20 is used for angular modes using the left-hand reference pixels 1905, where ref2≤2N, when the angle α<0 (refers to the bottom part of the left-hand reference pixels), and where the row of ref1 is odd. A second calculation shown in FIG. 21 is used for angular modes using the left-hand reference pixels 1905, where ref2≤2N, when the angle α≤0, and where the row of ref1 is even. A third calculation shown in FIG. 22 is used for angular modes using the left-hand reference pixels 1905, where ref2≤2N, when the angle α>0 (refers to the top part of the left hand reference pixels), and where the row of ref1 is odd. A fourth calculation shown in FIG. 23 is used for angular modes using the left-hand reference pixels 1905, where ref2≤2N, when the angle α>0, and where the row of ref1 is even. A fifth calculation shown in FIG. 24 is used for angular modes using top reference pixels only, where ref1≥2N.

FIG. 20 shows details for deriving of bilinear weights for angular modes using a bottom part of the left reference pixels where ref1 is on an odd row. FIG. 20 shows triangles 2050, derived from geometry of zigzag-square PU shape 600, where reference labels of triangles 2050 correspond to like labels of zigzag-square PU shape 600, and are solved below to calculate the bilinear weights.

As shown in FIG. 20, a pixel at location A represents the pixel that is to be predicted. Pixels at locations C and B are two reference pixels, ref1 and ref2, respectively. Directional line \vec{EA} denotes the angular prediction mode. To calculate bilinear weights, the following notation is defined:
w: bilinear weights with respect to ref1 (C), that is, the length of segment BE.
θ₁: −∠DAC
θ₂: −∠DAB
Intra prediction angle: α=−∠DAE
Edges of Triangle ACE: c=AB, a=BC, b=AC
Angles of Triangle: ∠A=∠BAC, ∠B=∠ABC, ∠C=ACD

The process to calculate the bilinear weights can be divided into two steps: first, solving triangle ABC and, second, solving triangle ABE.

First, the process includes solving triangle ABC to find a value for the length of the edge c:

$$∠ A = {θ}_{2} - {θ}_{1}$$

$$∠ C = 180 ° - 120 ° - \vert {θ}_{1} \vert$$

$$∠ B = 180 ° - ∠ A - ∠ C$$

$$c = \frac{sin ∠ C \cdot 1}{sin ∠ A}$$

Then, the process includes solving triangle ABE to find a value for the length of the edge BE, thus finding the bilinear weights with respect to ref1 (C):

$$w = \frac{c \cdot sin ( {θ}_{2} - α )}{sin ( 180 ° - ∠ B - ( {θ}_{2} - α ) )}$$

In other circumstances (e.g., for other triangles having different measurements), similar processes may be used to solve triangle ABC and triangle ABE, although different triangles will have various different angle and length measurements throughout.

FIG. 21 shows triangles 2150, derived from geometry of zigzag-square PU shape 600, where reference labels of triangles 2150 correspond to like labels of zigzag-square PU shape 600, and are solved below to calculate the bilinear weights.

As shown in FIG. 21, triangles 2150 show that the prediction mode direction is below the horizontal line and ref1 is even. In this case:

∠A=θ₂−θ₁

∠C=180°−60°−|θ₁|

∠B=180°−∠A−∠C

After finding the angles of the triangle ABC, the process includes solving triangle ABE to find a value for the length of the edge BE, thus finding the bilinear weights with respect to ref1 (C). This may be done in a similar manner as described above, for example, in FIG. 20.

In other circumstances (e.g., for other triangles having different measurements), similar processes may be used to solve triangle ABC and triangle ABE, although different triangles will have various different angle and length measurements.

FIG. 22 shows triangles 2250, derived from geometry of zigzag-square PU shape 600, where reference labels of triangles 2250 correspond to like labels of zigzag-square PU shape 600, and are solved below to calculate the bilinear weights where the prediction mode direction is above the horizontal line and ref1 is even. In this case:

∠A=θ₂−θ₁

∠B=180°−60°−|θ₂|

∠C=180°−∠A−∠B

After finding the angles of the triangle ABC, the process includes solving triangle ABE to find a value for the length of the edge BE, thus finding the bilinear weights with respect to ref1 (C). This may be done in a similar manner as described above, for example, in FIG. 20.

In other circumstances (e.g., for other triangles having different measurements), similar processes may be used to solve triangle ABC and triangle ABE, although different triangles will have various different angle and length measurements.

FIG. 23 shows triangles 2350, derived from geometry of zigzag-square PU shape 600, where reference labels of triangles 2350 correspond to like labels of zigzag-square PU shape 600, and are solved below to calculate the bilinear weights where the prediction direction is above the horizontal line and ref1 is even. In this case:

∠A=θ₂−θ₁

∠B=180°−120°−|θ₂|

∠C=180°−∠A−∠B

After finding the angles of the triangle ABC, the process includes solving triangle ABE to find a value for the length of the edge BE, thus finding the bilinear weights with respect to ref1 (C). This may be done in a similar manner as described above, for example, in FIG. 20.
In other circumstances (e.g., for other triangles having different measurements), similar processes may be used to solve triangle ABC and triangle ABE, although different triangles will have various different angle and length measurements.

FIG. 24 shows triangles 2450, derived from geometry of zigzag-square PU shape 600, where reference labels of triangles 2450 correspond to like labels of zigzag-square PU shape 600, and are solved below to calculate the bilinear weights where the reference pixels are at a top area of zigzag-square PU shape 600. In this case:

∠A=θ₂−θ₁

∠C=θ₁

∠B=180°−∠A−∠C

After finding the angles of the triangle ABC, the process includes solving triangle ABE to find a value for the length of the edge BE, thus finding the bilinear weights with respect to ref1 (C). This may be done in a similar manner as described above, for example, in FIG. 20.

In other circumstances (e.g., for other triangles having different measurements), similar processes may be used to solve triangle ABC and triangle ABE, although different triangles will have various different angle and length measurements.

FIG. 25 shows one example processing system 2500 that supports intra-prediction for hexagonally-sampled compression and decompression of videos and images, in embodiments. Processing system 2500 may represent image processing device 250 of FIG. 2. The processing system 2500 is provided as an example and is not to suggest or otherwise indicate any limitation as to scope of use or functionality, and it is contemplated herein that the described techniques may be implemented in diverse general-purpose or special-purpose computer systems as well as between or among any of, or any combination of: centralized, fixed, mobile, distributed, and/or other like communications systems.

Processing system 2500 includes one or more processing units, such as one or more central processing units (CPUs) 2510 and/or one or more graphics processing units (GPUs) 2520, and memory 2530. The processing units execute computer-executable instructions. A processing unit can be or include a general-purpose central processing unit (CPU), a processor in an application-specific integrated circuit (ASIC), and/or any other type of processor. In a multi-processing system, multiple processing units execute computer-executable instructions to increase processing power. Processing system 2500 is shown with a CPU 2510 as well as a GPU or co-processing unit 2520. The tangible memory 2530 may be volatile memory (e.g., registers, cache, random-access memory (RAM)), non-volatile memory (e.g., read-only memory (ROM), electrically erasable programmable ROM (EEPROM), flash memory, etc.), or some combination of the two, accessible by the processing unit(s). The memory 2530 may store software 2580 to implement one or more of the techniques described herein for intra-prediction for hexagonally-sampled compression and decompression of videos and images, in the form of computer-executable instructions suitable for execution by the processing unit(s). For example, software 2580 may represent one or more of hexagonal capture process 210, hexagonal-sampled video compression algorithm 215, and hexagonal display process 220 of FIG. 2.

Additionally, the processing system 2500 may have further features, such as one or more of the components: a storage 2540, one or more input devices 2550, one or more output devices 2560, and one or more communication connections 2570. An interconnection mechanism 2535 such as a bus, controller, or network interconnects the components of the processing system 2500. Typically, operating system software (not shown) provides an operating environment for other software executing in the processing system 2500, and coordinates activities of the components of the processing system 2500.

The tangible storage 2540 may be removable or non-removable, and includes magnetic media such as magnetic disks, magnetic tapes or cassettes, optical media such as compact discs (CD)-ROMs or digital video discs (DVDs), or any other medium which can be used to store information and which can be accessed within the processing system 2500. The storage 2540 stores instructions for the software 2580 to implement one or more of the techniques described herein for intra-prediction for hexagonally-sampled compression and decompression of videos and images.

For example, the CPU(s) 2510 may execute instructions stored on the memory 2580 and may cause the for the software 2580 to cause the device to determine a PU shape for performing intra-prediction on a block of pixels of a hexagonally-sampled image; intra-predict, based on the PU shape, a first pixel of the block of pixels to obtain a value for the first pixel; and encode the hexagonally-sampled image to produce encoded data based on the obtained value for the first pixel. In other examples, the CPU(s) 2510 may execute instructions stored on the memory 2580 and may cause the for the software 2580 to cause the device to decode an indication of a PU shape for performing intra-prediction on a block of pixels of a hexagonally-sampled image (e.g., an explicit indication, such as a flag, a particular information bit, or metadata indicating the PU shape, or, additionally or alternatively, an implicit or derived indication from which the device may process to determine the PU shape); determine the PU shape for performing intra-prediction on the block of pixels; and generate a PU based on the PU shape to obtain the block of pixels of the hexagonally-sampled image.

The input device(s) 2550 may, for example, be or include one or more of: a touch input device such as a keyboard, mouse, pen, or trackball; a voice input device; a scanning device; or another device that provides input to the processing system 2500. For video, the input device(s) 2550 may be a camera, video card, screen capture module, TV tuner card, or similar device that accepts video input in analog or digital form, or a CD-ROM or CD-rewritable (CD-RW) that reads video input into the processing system 2500. The output device(s) 2560 may be, for example, one or more of a display, printer, speaker, CD-writer, or other device that provides output from the processing system 2500.

The communication connection(s) 2570 enable communication over a communication medium via a wired or wireless link 2515 to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the processing system 2500, computer-readable media include memory 2530, storage 2540, and combinations thereof. Thus, the computer-readable media can be, for example, volatile memory, non-volatile memory, optical media, magnetic media, and the like (alone or any combinations thereof). As used herein, the term computer-readable media does not include transitory signals or propagating carrier waves.

The innovations can be described in the general context of computer-executable instructions, such as those included in program modules, being executed in a computer system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or computing device. In general, a computer system or computing device can be local and/or distributed, and can include any combination of special-purpose hardware and/or general-purpose hardware with software implementing the described operations and functions.

The disclosed methods can also be implemented using specialized computing hardware configured to perform any of the disclosed methods. For example, the disclosed methods can be implemented by an integrated circuit (e.g., an application-ASIC such as a digital signal processor (DSP), a GPU, a programmable logic device (PLD) such as a field-programmable gate array (FPGA), etc.) specially designed or configured to implement any of the disclosed techniques.

As used herein, the description uses terms like “select,” “determine,” “identify,” and the like, to describe computer operations in a computer system. These terms are high-level abstractions for operations performed by a computer, and should not be confused with acts performed by a human being. The actual computer operations corresponding to these terms vary depending on implementation.

FIGS. 26A and 26B show examples of network environments 2600 that support intra-prediction for hexagonally-sampled compression and decompression of videos and images, in embodiments. The network environments 2600 each include one or more encoders 2655 and one or more decoders 2660. The encoders 2655 and decoders 2660 may be connected over a network 2615 using an appropriate communication protocol. The network 2615 can include the Internet, a wireless network using one or more radio access technologies (implementing, e.g., fourth generation (4G) communications protocols such as Long Term Evolution (LTE) communications, fifth generation (5G) communications protocols which may be referred to as New Radio (NR) systems, or and/or Wi-Fi systems (such as wireless local area network (WLAN) systems), and/or or any other like network.

In the network environment 2600-a shown in FIG. 26A, each communications device includes an encoder 2655 and a decoder 2660 for bidirectional communication. A given encoder 2655 can produce output compliant with a variation or extension of the H.265/HEVC standard, SMPTE 421M standard, ISO/IEC 14496-10 standard (also known as H.264/AVC), another standard, or a proprietary format such as VP8 or VP9, with a corresponding decoder 2660 accepting encoded data from encoders 2655. The bidirectional communication can be part of a video conference, video telephone call, or other two-party or multi-party communication scenario. Although the network environment 2600-a in FIG. 26A shows two communications devices 2610, the network environment 2610 may include any number of devices that participate in multi-party communication.

The communications devices 2610 manage encoding by the encoders 2655 and decoding by the decoders 2660. In the network environment 2615 shown in FIG. 26B, the communications device 2610-c includes an encoder 2655-c that encodes video for delivery to multiple playback tools 2625 (e.g., a first playback tool 2625-a and a second playback tool 2625-b), where each playback tool 2625 includes one or more decoders 2660 (e.g., decoders 2660-d and 2660-e, respectively). The unidirectional communication can be provided, for example, for a video surveillance system, a web camera monitoring system, a remote desktop conferencing presentation, remote desktop sharing, wireless screen casting, cloud computing or gaming, or any other like scenario in which video is encoded and sent from one location to one or more other locations.

In some examples, the communications device 2610 determines a PU shape for performing intra-prediction on a block of pixels of a hexagonally-sampled image; intra-predict, based on the PU shape, a first pixel of the block of pixels to obtain a value for the first pixel; and encode (e.g., via the encoder 2655-c) the hexagonally-sampled image to produce encoded data based on the obtained value for the first pixel. In other examples, a device, such as the playback tools 2660, decodes (e.g., via its respective decoder 2660) an indication of a PU shape for performing intra-prediction on a block of pixels of a hexagonally-sampled image; determine the PU shape for performing intra-prediction on the block of pixels; and generate a PU based on the PU shape to obtain the block of pixels of the hexagonally-sampled image.

Although the network environment 2615 in FIG. 26B shows two playback tools 2625, the network environment 2615 may instead include any number of devices that participate in multi-party communication. In general, a playback tool 2625 communicates with the communications device 2610 to determine a stream of video for the playback tool 2625 to receive. The playback tool 2625 receives the stream, buffers the received encoded data for an appropriate period, begins decoding, and plays back the stream.

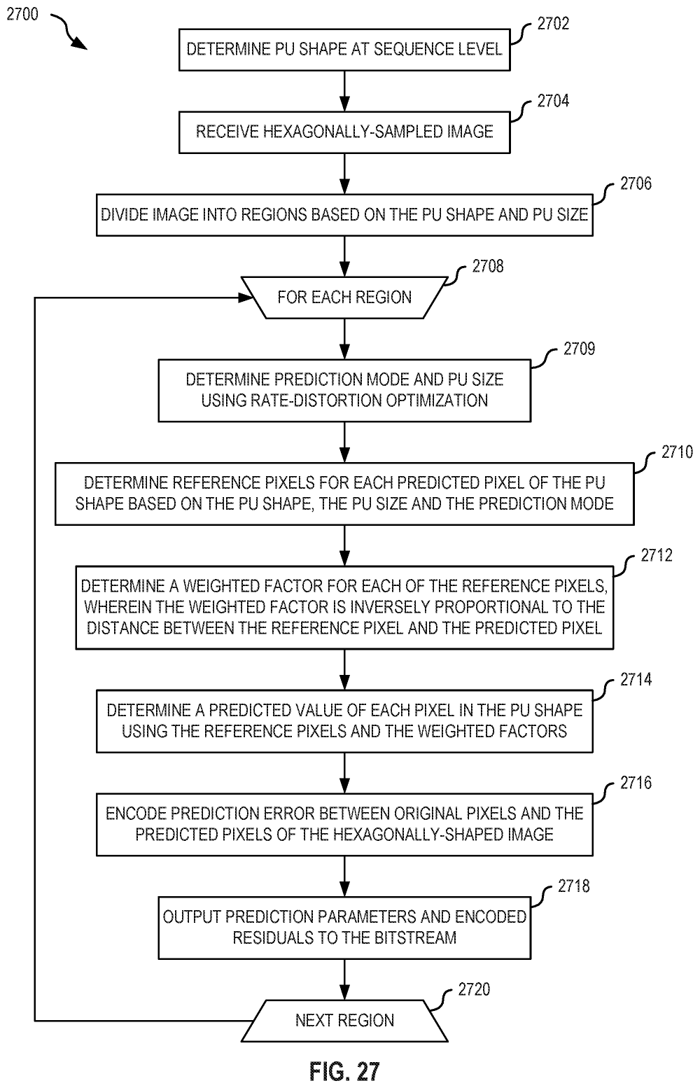

FIG. 27 is a flowchart illustrating one example method 2700 for encoding a hexagonally-sampled image that supports intra-prediction for compression of hexagonally-sampled videos and images, in embodiments. In embodiments, at least part of method 2700 may be implemented by a device including an encoder and a device including a decoder, shown in FIGS. 26A and 26B as an encoding device and a decoding device, respectively. Various devices described herein, for example the devices as described in FIGS. 1-2 and 25-26B, among the other devices described herein may be examples of the encoding device and the decoding device. In certain embodiments, method 2700 is implemented by CPU 2510 and/or GPU 2520 executing computer-readable instructions of software 2580. In some examples, the device or devices may execute a set of instructions to control the functional elements of the device to perform the functions described below. Additionally, or alternatively, a device may perform aspects of the functions described below using special-purpose hardware. The blocks of method 2700 may be implemented in a different order than described, or may be omitted, without departing from the scope hereof. In certain embodiments, method 2700 may include additional block (e.g., that are common to encoding algorithms) not mentioned below.

In block 2702, method 2700 determines a PU shape at a sequence level. In one example of block 2702, for a sequence of images (e.g., a video), the PU shape is selected from the group consisting of the parallelogram PU shape 500 in FIG. 5, the zigzag-square PU shape 600 in FIGS. 6 and 7, the arrow PU shape 800 in FIG. 8, the rectangular zigzag PU shape 900 in FIG. 9, and other similar PU shapes.

In block 2704, method 2700 receives a hexagonally-sampled image. In one example of block 2704, hexagonal capture process 210 of image processing device 250 of FIG. 2 captures real-world scene 205 as a hexagonally-sampled image. In another example of block 2704, hexagonal capture process 210 receives or captures a square-sampled image of real-world scene 205, and then generates a hexagonally-sampled image from the square-sampled image.

In block 2706, method 2700 divides the hexagonally-sampled image into regions based on the selected PU shape. In one example of block 2706, the image to be compressed is divided into regions based on the best PU shape.

Block 2708 is the start of a loop that repeats for each region of the image. That is, each PU shaped region is then processed using a raster scan approach for example.

In block 2709, method 2700 determines a prediction mode and a PU size using rate-distortion optimization. In one example of block 2709, each prediction mode (e.g., planar, angular, DC) and each PU sizes for the selected PU shape are used to process the current region of the hexagonally-sampled image and the prediction mode and the PU size are selected for subsequent image processing based on minimizing a resulting rate-distortion, where rate is the number of bits to transmit the PU shape, and distortion is the mean-squared-error measured between original pixels of the PU shape and predicted pixels of the PU shape.

In block 2710, method 2700 determines reference pixels for each predicted pixel of the PU shape based on the PU shape, the PU size, and the prediction mode. In one example of block 2710, where the PU shape is a parallelogram, the top reference pixels are in a horizontal line above and adjacent to the PU shape and the left reference pixels are parallel to a left edge of the PU shape and are in a line that is “tilted” 30°. For example, the prediction mode, PU shape, and PU size are used to determine the reference pixels as shown in FIGS. 14A-18.

In block 2712, method 2700 determines a weighted factor for each of the reference pixels, wherein the weighted factor is inversely proportional to the distance between the reference pixel and the predicted pixel. In one example of block 2712, for each pixel in the PU shape, bilinear weights are calculated for each reference pixel based on the prediction mode and the distance between the reference pixel and the predicted pixel.

In block 2714, method 2700 determines a predicted value of each pixel in the PU shape using the corresponding reference pixels and weighted factors. In one example of block 2714, software 2850 uses bilinear interpolation to calculate a value for pixel P_{1,2} based on reference pixels R_{0,0}, R_{0,2}, and R_{2,0} and corresponding bilinear weighting factors.

In block 2716, method 2700 encodes the prediction error between the original pixels and the predicted pixels of the encoded hexagonally-sampled image. In one example of block 2716, the prediction error (e.g., referred to as residue) between the original pixel values of the image and the predicted pixel values of the image are converted to the frequency domain with quantization and entropy coding (e.g., DCT transform and then quantize the transform coefficients).

In block 2718, method 2700 outputs the prediction parameters and the encoded residuals to the bitstream. In one example of block 2718, software 2580 outputs the selected prediction mode, the selected PU size, and the encoded residuals to the output bitstream.

Block 2720 is the end of the loop and method 2700 returns to block 2708 to repeat steps 2709 through 2718 for each region of the hexagonally-sampled image.

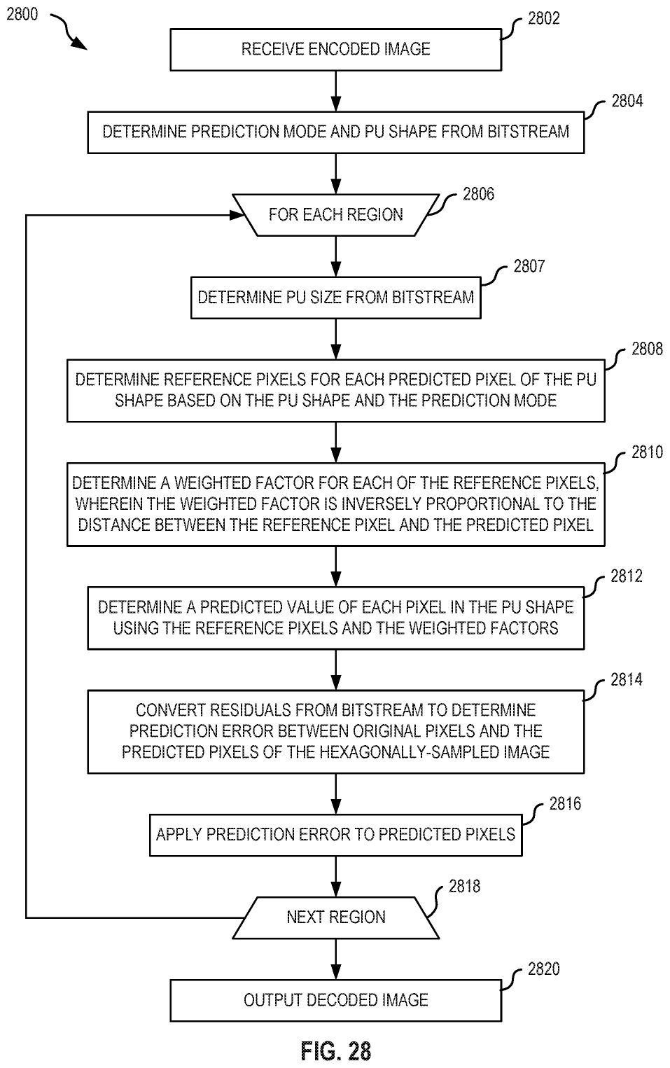

FIG. 28 is a flowchart illustrating one example method 2800 for decoding an encoded hexagonally-sampled image that uses intra-prediction. Method 2800 may be implemented in a device that receives and decodes compressed hexagonally-sampled images. For example, method 2800 may be implemented in one or more of image processing device 250 of FIG. 2, in software 2580 of device 2500, FIG. 25, and in decoder 2660 of devices 2610 of FIGS. 26A and 26B.

In block 2802, method 2800 receives an encoded image. In one example of block 2802, playback tool 2625 receives an encoded signal including the encoded data for the hexagonally-sampled image encoded by method 2700 of FIG. 27. In block 2804, method 2800 determines the prediction mode and PU shape from the bitstream of the encoded data. In one example of block 2804, decoder 2660 determines from metadata in the bitstream of the encoded hexagonally-sampled image that the prediction mode is mode “5” and the PU shape is zigzag-square.

Block 2806 is the start of a loop, implemented by blocks 2806 through 2814, that iterates over each region of the image based on the PU shape. In block 2807, method 2800 determines a PU size from the bitstream. In one example of block 2807, decoder 2660 decodes metadata of the bitstream to determine a current PU size of the PU shape.

In block 2808, method 2800 determines reference pixels for each predicted pixel of the PU shape based on the PU shape and the prediction mode. In one example of block 2808, decoder 2660 identifies reference pixels 605 for the zigzag-square PU shape 600 of FIG. 6. In block 2810, method 2800 determines a weighted factor for each of the reference pixels, wherein the weighted factor is inversely proportional to the distance between the reference pixel and the predicted pixel. In one example of block 2810, decoder 6220 determines a weighted factor for reference pixels B and C based on calculated lengths c and b, respectively, as shown in FIG. 20. In block 2812, method 2800 determines a predicted value of each pixel in the PU shape using the reference pixels and the weighted factors. In one example of block 2812, decoder 2660 determines a value for pixel A based on the determined weighted factors and values of reference pixels B and C.

In block 2814, method 2800 decodes residuals from the transform domain (e.g., DCT transform) as received in the bitstream to the pixel domain as the prediction error between the original pixels and the predicted pixels of the hexagonally-sampled image. In one example, of block 2814, decoder 2660 determines the prediction error by decoding the entropy-coded quantized frequency-domain components. In block 2816, method 2800 applies the predicted error to the predicted pixels. In one example of block 2816, decoder applies the predicted error to the predicted pixels to generate the hexagonally-sampled image.

Block 2818 is the end of the loop and method 2800 returns to block 2806 to repeat blocks 2807 through 2816 for each region of the image to determine predicted pixel values from the reference pixels based at least in part on the PU shape, PU size, and the prediction mode.

In block 2820, method 2800 outputs the decoded image. In one example of block 2820, decoder 2660 outputs the hexagonally-sampled image. In another example of block 2820, decoder 2660 converts the hexagonally-sampled image to a rectangularly-sampled image, and outputs the rectangularly-sampled image.

Features described above, as well as those claimed below, may be combined in various ways without departing from the scope hereof. The following enumerated examples illustrate some possible, non-limiting combinations.

(A1) A method for intra prediction of a hexagonally-sampled image having a regular grid of hexagonally-shaped pixels, includes defining a prediction unit (PU) shape having a plurality of hexagonal pixels, and uses the defined PU shape to perform intra-prediction on a block of pixels of the hexagonally-sampled image.

(A2) In embodiments of the method (A1), the intra prediction further includes an angular prediction mode.

(A3) In embodiments of either of the methods (A1) and (A2), the PU shape is a parallelogram PU formed as an N×N skewed square of hexagonally-shaped pixel, where the skew is at an angle of 60 degrees with reference to horizontal.

(A4) In embodiments of any of the methods (A1)-(A3), the parallelogram PU has top reference pixels forming a horizontal line adjacent to a top edge of the PU shape, and left reference pixels forming a straight line of pixels at an angle of 60 degrees adjacent a left edge of the PU shape.

(A5) In embodiments of either of the methods (A1) and (A2), the PU shape is a zigzag-square PU formed with an even number of rows, where each row has a half-pel offset with respect to adjacent rows.

(A6) In embodiments of any of the methods (A1), (A2), and (A5), the zigzag-square PU has top reference pixels forming a horizontal line adjacent to a top edge of the PU shape, and left reference pixels form a zigzag vertical line, where each row has a half-pel offset with respect to adjacent rows, positioned adjacent a left edge of the PU shape.

(A7) In embodiments of either of the methods (A1) and (A2), the PU shape is a rectangular-zigzag PU formed with an odd number of rows, where each row has a half-pel offset with respect to adjacent rows.

(A8) In embodiments of any of the methods (A1), (A2), and (A7), the rectangular-zigzag PU has top reference pixels forming a horizontal line adjacent to a top edge of the PU shape, and left reference pixels forming a zigzag vertical line, where each row has a half-pel offset with respect to adjacent rows, positioned adjacent the left edge of the PU shape.

(A9) In embodiments of either of the methods (A1) and (A2), the PU shape is a super-pixel PU having a hexagonal shape of level L, where L represents a number of layers of hexagonal pixels forming the super-pixel PU.

(A10) In embodiments of any of the methods (A1), (A2), and (A9), the super-pixel PU has top reference pixels forming a repeating partial inverted hexagonal outline adjacent to a top edge of the PU shape, and left reference pixels forming a repeating partial hexagonal outline adjacent to left edges of the PU shape.

(A11) In embodiments of either of the methods (A1) and (A2), the PU shape is an arrow PU having a convex vertex and a matching inverted vertex on horizontally opposed sides.

(A12) In embodiments of any of the methods (A1), (A2), and (A11), the arrow PU has top reference pixels forming a horizontal line adjacent to a top edge of the PU shape, and left reference pixels forming a repeating convex shape adjacent the inverted vertex.

(A13) In embodiments of either of the methods (A1) and (A2), the PU shape is a parallelogram PU, the method further includes setting, or arranging, a table including a plurality of intra prediction modes respectively corresponding to a plurality of intra prediction angles, and selecting, for encoding/decoding the hexagonally-sampled image, one of the plurality of intra prediction modes, from the set, or arranged, table, wherein a number of the plurality of intra prediction modes included in the set, or arranged, table is 33, the set, or arranged, table including:

| | predModeIntra | | | | | | | | | | |
|---|---|---|---|---|---|---|---|---|---|---|---|
| | 2 | 3 | 4 | 5 | 6 | 7 | 8 | 9 | 10 | 11 | 12 |
| intraPredAngle | 32 | 22 | 15 | 9 | 4 | 0 | −3 | −6 | −9 | −12 | −15 |

| | predModeIntra | | | | | | | | | | |
|---|---|---|---|---|---|---|---|---|---|---|---|
| | 13 | 14 | 15 | 16 | 17 | 18 | 19 | 20 | 21 | 22 | 23 |
| intraPredAngle | −17 | −20 | −23 | −26 | −29 | −32 | −29 | −26 | −23 | −20 | −17 |

| | predModeIntra | | | | | | | | | | |
|---|---|---|---|---|---|---|---|---|---|---|---|
| | 24 | 25 | 26 | 27 | 28 | 29 | 30 | 31 | 32 | 33 | 34 |
| intraPredAngle | −15 | −12 | −9 | −6 | −3 | 0 | 4 | 9 | 15 | 22 | 32 |

(A14) In embodiments of either of the methods (A1) and (A2), the PU shape is a zigzag-square PU and for an angular mode, the method further includes determining a bilinear weight

$$w = \frac{c \cdot sin ( {θ}_{2} - α )}{sin ( 180 ° - ∠ B - ( {θ}_{2} - α ) )} , where c = \frac{sin ∠ C \cdot 1}{sin ∠ A} ,$$

wherein A represents a location of a predicted pixel, C represents a location of a reference pixel ref1 and B represents a location of a reference pixel ref2, D represents a location of a pixel horizontally aligned with A and aligned with edge BC, and E represents an intersection between edge BC and a directional line AE from A at an intra-prediction angle α defined by the angular mode, and wherein w represents a bilinear weight with respect to ref1 defined by a length of edge BE, θ₁ is an angle subtended by locations DAC, θ₂ is an angle defined by locations DAB, a represents edge BC, b represents edge AC, c represents edge AB, and wherein ∠A represents an angle subtended by locations BAC, ∠B represents and angle subtended by locations ABC, and ∠C represents an angle subtended by locations ACD; for left-hand reference pixels where the angular mode defines an angle α, relative to a horizonal direction, that is less than 0, and where the reference pixel ref1 is on an odd row: ∠A=θ₂−θ₁, ∠C=180°−120°−|θ₁|, and ∠B=180°−∠A−∠C; for left-hand reference pixels where the angular mode defines an angle α, relative to a horizonal direction, that is less than 0, and where the reference pixel ref1 is on an even row: ∠A=θ₂−θ₁, ∠C=180°−60°−|θ₁|, and ∠B=180°−∠A−∠C; for left-hand reference pixels where the angular mode defines an angle α, relative to a horizonal direction, that is greater than 0, and where the reference pixel ref1 is on an odd row: ∠A=θ₂−θ₁, ∠B=180°−60°−|θ₂|, and ∠C=180°−∠A−∠B; for left-hand reference pixels where the angular mode defines an angle α, relative to a horizonal direction, that is greater than 0, and where the reference pixel ref1 is on an even row: ∠A=θ₂−θ₁, ∠B=180°−120°−|θ₂|, and ∠C=180°−∠A−∠B; and for top reference pixels, ∠A=θ₂−θ₁, ∠C=θ₁, and ∠B=180°−∠A−∠C.

(A15) In embodiments of either of the methods (A1) and (A2), the PU shape is a zigzag-square PU shape, and for a planar mode, the method further includes: selecting a first reference pixel from a horizonal direction from a predicted pixel and copying a second reference pixel from a 60° direction from the predicted pixel; determining a first predicted value using bilinear interpolation of the first reference pixel and the second reference pixel; selecting a third reference pixel from a 60° direction from the predicted pixel and copying a fourth reference pixel from a 120° direction from the predicted pixel; determining a second predicted value using bilinear interpolation of the third reference pixel and the fourth reference pixel; selecting fifth reference pixel from a 120° direction from the predicted pixel and copying a sixth reference pixel from a horizontal direction from the predicted pixel; determining a third predicted value using bilinear interpolation of the fifth reference pixel and the sixth reference pixel; and determining the predicted value by averaging the first predicted value, the second predicted value and the third predicted value.

(A16) In embodiments of either of the methods (A1) and (A2), the PU shape is a zigzag-square PU shape, and for a DC mode, the method further includes determining dcVal using:

$$dcVal = ( {\sum }_{x = 1}^{N} {R}_{x , 0} + {\sum }_{y = 1}^{N} {R}_{0 , y} + N ) ≫ ( {log}_{2} ( N ) + 1 )$$

determining a first predicted pixel P1,1 using:

P_{1,1}=(R_{0,2}+R_{0,1}+R_{0,0}+R_{1,0}+2)>>2;
determining top row predicted pixels Px,1 using:

P_{x,1}=(R_{x-1,0}+R_{x,0}+2·dcVal+2)>>2;
determining left predicted pixels P1,y for even rows using:

P_{1,y}=(R_{0,y}+3·dcVal+2)>>2; and
determining left predicted pixels P1,y for odd rows using:

P_{1,y}=(R_{0,y-1}+R_{0,y}+R_{0,y+1}+dcVal+2)>>2;
where Rx,y are reference pixels of the zigzag-square PU.

(B1) A method encodes/decodes a hexagonally-sampled image having a regular grid of hexagonally-shaped pixels using a conventional High Efficiency Video Coding (HEVC) implementation. Each row of the hexagonally-sampled image is shifted by a pixel distance Δ, to generate forward shifted image, where

$$Δ = ⌈ \frac{y}{2} ⌉ ,$$

y=0, 1, . . . , hₕ−1, and hₕ is the height of the hexagonally-sampled image. The forward shifted image is input to the conventional HEVC implementation to generate a bitstream for output.

(C1) A method converts a square-sampled image to a hexagonally-sampled image. A height of the hexagonally-sampled image hₕ is calculated and the square-sampled image is interpolated to increase its height from hₛ to hₕ. An 8-tap filter is applied to all even rows of the increased height square-sampled image to determine half-pel values of the hexagonally-sampled image.

(C2) In embodiments of the method (C1), the height hₕ is calculated using the formula

$${h}_{h} = ⌊ \frac{{h}_{s}}{\sqrt{3} / 2} ⌋ ,$$

where hₛ is a height of the square-sampled image and a width of the hexagonally-sampled image remains the same as a width of the square-sampled image.

(C3) In embodiments of either of the methods (C1) and C2), the interpolating further includes a bicubic interpolation algorithm.

(C4) In embodiments of any of the methods (C1)-(C3), the 8-tap filter uses MPEG-specified 8-tap filter weights.

Changes may be made in the above systems, products, and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present systems, products, and methods, which, as a matter of language, might be said to fall therebetween.

1. A method for intra prediction of a hexagonally-sampled image having a regular grid of hexagonally-shaped pixels, comprising:
defining a prediction unit (PU) shape comprising a plurality of hexagonal pixels; and
using the defined PU shape to perform intra-prediction on a block of pixels of the hexagonally-sampled image.

2. The method of claim 1, the PU shape comprising a parallelogram PU formed as an N×N skewed square of hexagonally-shaped pixel, where the skew is at an angle of 60 degrees with reference to horizontal.

3. The method of claim 2, the parallelogram PU having top reference pixels forming a horizontal line adjacent to a top edge of the PU shape, and left reference pixels forming a straight line of pixels at an angle of 60 degrees adjacent a left edge of the PU shape.

4. The method of claim 1, the PU shape comprising a zigzag-square PU formed with an even number of rows, where each row has a half-pel offset with respect to adjacent rows.

5. The method of claim 4, the zigzag-square PU having top reference pixels forming a horizontal line adjacent to a top edge of the PU shape, and left reference pixels form a zigzag vertical line, where each row has a half-pel offset with respect to adjacent rows, positioned adjacent a left edge of the PU shape.

6. The method of claim 1, the PU shape comprising a rectangular-zigzag PU formed with an odd number of rows, where each row has a half-pel offset with respect to adjacent rows.

7. The method of claim 6, the rectangular-zigzag PU having top reference pixels forming a horizontal line adjacent to a top edge of the PU shape, and left reference pixels forming a zigzag vertical line, where each row has a half-pel offset with respect to adjacent rows, positioned adjacent the left edge of the PU shape.

8. The method of claim 1, the PU shape comprising a super-pixel PU having a hexagonal shape of level L, where L represents a number of layers of hexagonal pixels forming the super-pixel PU.

9. The method of claim 8, the super-pixel PU having top reference pixels forming a repeating partial inverted hexagonal outline adjacent to a top edge of the PU shape, and left reference pixels forming a repeating partial hexagonal outline adjacent to left edges of the PU shape.

10. The method of claim 1, the PU shape comprising an arrow PU having a convex vertex and a matching inverted vertex on horizontally opposed sides.

11. The method of claim 10, the arrow PU having top reference pixels forming a horizontal line adjacent to a top edge of the PU shape, and left reference pixels forming a repeating convex shape adjacent the inverted vertex.

12. The method of claim 1, the PU shape comprising a parallelogram PU, the method further comprising:
setting a table including a plurality of intra prediction modes respectively corresponding to a plurality of intra prediction angles; and
selecting, for encoding/decoding the hexagonally-sampled image, one of the plurality of intra prediction modes, from the set table, wherein a number of the plurality of intra prediction modes included in the set table is 33, the set table including:

| | predModeIntra | | | | | | | | | | |
|---|---|---|---|---|---|---|---|---|---|---|---|
| | 2 | 3 | 4 | 5 | 6 | 7 | 8 | 9 | 10 | 11 | 12 |
| intraPredAngle | 32 | 22 | 15 | 9 | 4 | 0 | −3 | −6 | −9 | −12 | −15 |
| | predModeIntra | | | | | | | | | | |
|---|---|---|---|---|---|---|---|---|---|---|---|
| | 13 | 14 | 15 | 16 | 17 | 18 | 19 | 20 | 21 | 22 | 23 |
| intraPredAngle | −17 | −20 | −23 | −26 | −29 | −32 | −29 | −26 | −23 | −20 | −17 |
| | predModeIntra | | | | | | | | | | |
|---|---|---|---|---|---|---|---|---|---|---|---|
| | 24 | 25 | 26 | 27 | 28 | 29 | 30 | 31 | 32 | 33 | 34 |
| intraPredAngle | −15 | −12 | −9 | −6 | −3 | 0 | 4 | 9 | 15 | 22 | 32 |

13. The method of claim 1, the PU shape comprising a zigzag-square PU and for an angular mode, the method further comprising:
determining a bilinear weight
$$w = \frac{c \cdot sin ( {θ}_{2} - α )}{sin ( 180 ° - ∠ B - ( {θ}_{2} - α ) )} , where c = \frac{sin ∠ C \cdot 1}{sin ∠ A} ,$$
wherein A represents a location of a predicted pixel, C represents a location of a reference pixel ref1 and B represents a location of a reference pixel ref2, D represents a location of a pixel horizontally aligned with A and aligned with edge BC, and E represents an intersection between edge BC and a directional line AE from A at an intra-prediction angle α defined by the angular mode, and
wherein w represents a bilinear weight with respect to ref1 defined by a length of edge BE, θ₁ is an angle subtended by locations DAC, θ₂ is an angle defined by locations DAB, a represents edge BC, b represents edge AC, c represents edge AB, and
wherein ∠A represents an angle subtended by locations BAC, ∠B represents and angle subtended by locations ABC, and ∠C represents an angle subtended by locations ACD;
for left-hand reference pixels where the angular mode defines an angle α, relative to a horizonal direction, that is less than 0, and where the reference pixel ref1 is on an odd row: ∠A=θ₂−θ₁, ∠C=180°−120°−|θ₁|, and ∠B=180°−∠A−∠C;
for left-hand reference pixels where the angular mode defines an angle α, relative to a horizonal direction, that is less than 0, and where the reference pixel ref1 is on an even row: ∠A=θ₂−θ₁, ∠C=180°−60°−|θ₁|, and ∠B=180°−∠A−∠C;
for left-hand reference pixels where the angular mode defines an angle α, relative to a horizonal direction, that is greater than 0, and where the reference pixel ref1 is on an odd row: ∠A=θ₂−θ₁, ∠B=180°−60°−|θ₂|, and ∠C=180°−∠A−∠B;
for left-hand reference pixels where the angular mode defines an angle α, relative to a horizonal direction, that is greater than 0, and where the reference pixel ref1 is on an even row: ∠A=θ₂−θ₁, ∠B=180°−120°−|θ₂|, and ∠C=180°−∠A−∠B; and
for top reference pixels, ∠A=θ₂−θ1, ∠C=θ₁, and ∠B=180°−∠A−∠C.

14. The method of claim 1, the PU shape comprising a zigzag-square PU shape, and for a planar mode, the method further comprising:
selecting a first reference pixel from a horizonal direction from a predicted pixel and copying a second reference pixel from a 60° direction from the predicted pixel;
determining a first predicted value using bilinear interpolation of the first reference pixel and the second reference pixel;
selecting a third reference pixel from a 60° direction from the predicted pixel and copying a fourth reference pixel from a 120° direction from the predicted pixel;
determining a second predicted value using bilinear interpolation of the third reference pixel and the fourth reference pixel;
selecting fifth reference pixel from a 120° direction from the predicted pixel and copying a sixth reference pixel from a horizontal direction from the predicted pixel;
determining a third predicted value using bilinear interpolation of the fifth reference pixel and the sixth reference pixel; and
determining the predicted value by averaging the first predicted value, the second predicted value and the third predicted value.

15. The method of claim 1, the PU shape comprising a zigzag-square PU shape, and for a DC mode, the method further comprising:
determining dcVal using:
$$dcVal = ( {\sum }_{x = 1}^{N} {R}_{x , 0} + {\sum }_{y = 1}^{N} {R}_{0 , y} + N ) ≫ ( {log}_{2} ( N ) + 1 )$$
determining a first predicted pixel P_{1,1} using:
P_{1,1}=(R_{0,2}+R_{0,1}+R_{0,0}+R_{1,0}+2)>>2;
determining top row predicted pixels P_{x,1} using:
P_{x,1}=(R_{x-1,0}+R_{x,0}+2·dcVal+2)>>2;
determining left predicted pixels P_{1,y} for even rows using:
P_{1,y}=(R_{0,y}+3·dcVal+2)>>2; and
determining left predicted pixels P_{1,y} for odd rows using:
P_{1,y}=(R_{0,y-1}+R_{0,y}+R_{0,y+1}+dcVal+2)>>2;
where R_{x,y} are reference pixels of the zigzag-square PU.
